(19) United States
(12) Patent Application Publication
(10) Pub. No.: US 2016/0277743 A1
(43) Pub. Date: Sep. 22, 2016

(54) Evaluation Measure for HDR Video Frames

(71) Applicant: TELEFONAKTIEBOLAGET L M ERICSSON (PUBL), Stockholm (SE)

(72) Inventor: Jacob Ström, Stockholm (SE)

(73) Assignee: Telefonaktiebolaget L M Ericsson (publ), Stockholm (SE)

(21) Appl. No.: 14/785,966

(22) PCT Filed: Sep. 24, 2015
(86) PCT No.: PCT/SE2015/050998

§ 371 Date: Oct. 21, 2015

Related U.S. Application Data
(60) Provisional application No. 62/060,155, filed on Oct. 6, 2014.

(51) Int. Cl. H04N 19/136; H04N 19/65; H04N 19/90; H04N 19/426

(52) U.S. Cl. CPC H04N 19/136; H04N 19/426; H04N 19/65; H04N 19/90

(57) ABSTRACT

An evaluation measure for HDR video frames (10) is calculated by calculating initial exposure values of pixels using a smallest exposure parameter value and calculating additional exposure values from previously calculated exposure values and a constant. The exposure values are converted into LDR values and used to calculate an error. The evaluation measure is then calculated based on the errors of all pixels in the HDR video frame (10) and for all exposure parameter values.

### TECHNICAL FIELD

The present embodiments generally relate to evaluation measures for high dynamic range (HDR) video frames, and in particular such an evaluation measure that can be used in connection with encoding and compressing HDR video frames and video.

### BACKGROUND

In the art of regular low dynamic range (LDR) video, also known as standard dynamic range (SDR) video, peak signal-to-noise ratio (PSNR) has been used for long time as an objective evaluation measure to represent the quality of reconstruction of lossy compression codecs. Although not a perfect measure, PSNR has served its purpose well for SDR video.

In the Moving Picture Experts Group (MPEG) ad hoc group on high dynamic range/wide color gamut (HDR/WGC) one of the investigations is aimed at finding an objective evaluation measure for HDR video. The reason being that PSNR works much worse for HDR video than for LDR video. Alternative evaluation measures adapted for HDR video have thereby been brought forward.

HDR video produces a greater dynamic range of luminosity than is possible with LDR video. A feature of HDR video is to present the human eye with a similar range of luminance as that which, through the visual system, is familiar in everyday life.

The two primary types of HDR video are computer renderings and video resulting from merging multiple LDR or SDR cameras. HDR video can also be acquired using special image sensors, like an oversampled binary image sensor. LDR video is typically represented by 8 bits per color component or channel, i.e. 24 bits per pixel (bpp) when using the red, green, blue (RGB) color space. HDR video may correspondingly be represented by using a 16-bit floating-point number per color component, resulting in 48 bpp when using the RGB color space.

For still HDR images, multi-exposure PSNR (mPSNR) has been proposed [1] as evaluation measure. This evaluation measure is, however, not applicable to HDR video since shutter speed values are manually selected.

Thus, there is still a need for improvements within the field of evaluation measures and in particular for such evaluation measures used for HDR video.

### SUMMARY

It is a General Objective to Provide an Evaluation Measure Suitable for HDR Video Frames.

It is a particular objective to provide an improved and/or fast solution for determining such evaluation measures.

These and other objectives are met by embodiments as disclosed herein.

An aspect of the embodiments relates to a method for determining an evaluation measure for a high dynamic range (HDR) video frame. The method comprises calculating, for each pixel in the HDR video frame, an initial exposure value of the pixel in the HDR video frame using a smallest exposure parameter value. The method also comprises calculating, for each pixel in the HDR video frame, an initial exposure value of a corresponding pixel in a version of the HDR video frame obtained following compression of the HDR video frame. The method further comprises calculating, for each pixel in the HDR video frame and for each exposure parameter value starting from the smallest exposure parameter value up to a largest exposure parameter value, an exposure value of the pixel in the HDR video frame from a previously calculated exposure value of the pixel in the HDR video frame multiplied by a constant. The method further comprises calculating, for each pixel in the HDR video frame and for each exposure parameter value, an exposure value of the corresponding pixel in the version of the HDR video frame obtained following compression of the HDR video frame from a previously calculated exposure value of the corresponding pixel in the version of the HDR video frame obtained following compression of the HDR video frame multiplied by the constant. The method additionally comprises converting, for each pixel in the HDR video frame and for each exposure parameter value, the exposure value of the pixel in the HDR video frame into a low dynamic range (LDR) value for the pixel in the HDR video frame. The method also comprises converting, for each pixel in the HDR video frame and for each exposure parameter value, the exposure value of the corresponding pixel in the version of the HDR video frame obtained following compression of the HDR video frame into a LDR value for the corresponding pixel in the version of the HDR video frame obtained following compression of the HDR video frame. The method additionally comprises calculating, for each pixel in the HDR video frame and for each exposure parameter value, an error representing a difference between the LDR value for the pixel in the HDR video frame and the LDR value for the corresponding pixel in the version of the HDR video frame obtained following compression of the HDR video frame. The method further comprises calculating the evaluation measure based on the errors for all pixels in the HDR video frame and for all exposure values.

Another aspect of the embodiments relates to an encoder for determining an evaluation measure for a HDR video frame. The encoder is configured to calculate, for each pixel in the HDR video frame, an initial exposure value of the pixel in the HDR video frame using a smallest exposure parameter value. The encoder is also configured to calculate, for each pixel in the HDR video frame, an initial exposure value of a corresponding pixel in a version of the HDR video frame obtained following compression of the HDR video frame. The encoder is further configured to calculate, for each pixel in the HDR video frame and for each exposure parameter value starting from the smallest exposure parameter value up to a largest exposure parameter value, an exposure value of the pixel in the HDR video frame from a previously calculated exposure value of the pixel in the HDR video frame multiplied by a constant. The encoder is additionally configured to calculate, for each pixel in the HDR video frame and for each exposure parameter value, an exposure value of the corresponding pixel in the version of the HDR video frame obtained following compression of the HDR video frame from a previously calculated exposure value of the corresponding pixel in the version of the HDR video frame obtained following compression of the HDR video frame multiplied by the constant. The encoder is also configured to convert, for each pixel in the HDR video frame and for each exposure parameter value, the exposure value of the pixel in the HDR video frame into a LDR value for the pixel in the HDR video frame. The encoder is further configured to convert, for each pixel in the HDR video frame and for each exposure parameter value, the exposure value of the corresponding pixel in the version of the HDR video frame obtained following compression of the HDR video frame into a LDR value for the corresponding pixel in the version of the HDR video frame obtained following compression of the HDR video frame. The encoder is additionally configured to calculate, for each pixel in the HDR video frame and for each exposure parameter value, an error representing a difference between the LDR value for the pixel in the HDR video frame and the LDR value for the corresponding pixel in the version of the HDR video frame obtained following compression of the HDR video frame. The encoder is also configured to calculate the evaluation measure based on the errors for all pixels in the HDR video frame and for all exposure parameter values.

A related aspect of the embodiments defines an encoder for determining an evaluation measure for a HDR video frame. The encoder comprises an initial exposure value calculator for calculating, for each pixel in the HDR video frame, i) an initial exposure value of the pixel in the HDR video frame using a smallest exposure parameter value and ii) an initial exposure value of a corresponding pixel in a version of the HDR video frame obtained following compression of the HDR video frame. The encoder also comprises an exposure value calculator for calculating, for each pixel in the HDR video frame and for each exposure parameter value starting from the smallest exposure parameter value up to a largest exposure parameter value, i) an exposure value of the pixel in the HDR video frame from a previously calculated exposure value of the pixel in the HDR video frame multiplied by a constant and ii) an exposure value of the corresponding pixel in the version of the HDR video frame obtained following compression of the HDR video frame from a previously calculated exposure value of the corresponding pixel in the version of the HDR video frame obtained following compression of the HDR video frame multiplied by the constant. The encoder further comprises an exposure value converter for converting, for each pixel in the HDR video frame and for each exposure parameter value, i) the exposure value of the pixel in the HDR video frame into a LDR value for the pixel in the HDR video frame and ii) the exposure value of the corresponding pixel in the version of the HDR video frame obtained following compression of the HDR video frame into a LDR value for the corresponding pixel in the version of the HDR video frame obtained following compression of the HDR video frame. The encoder additionally comprises an error calculator for calculating, for each pixel in the HDR video frame and for each exposure parameter value, an error representing a difference between the LDR value for the pixel in the HDR video frame and the LDR value for the corresponding pixel in the version of the HDR video frame obtained following compression of the HDR video frame. The encoder also comprises an evaluation measure calculator for calculating the evaluation measure based on the errors for all pixels in the HDR video frame and for all exposure parameter values.

A further aspect of the embodiment relates to a computer program comprising instructions, which when executed by a processor, cause the processor to calculate, for each pixel in the HDR video frame, an initial exposure value of the pixel in the HDR video frame using a smallest exposure parameter value. The processor is also caused to calculate, for each pixel in the HDR video frame, an initial exposure value of a corresponding pixel in a version of the HDR video frame obtained following compression of the HDR video frame. The processor is further caused to calculate, for each pixel in the HDR video frame and for each exposure parameter value starting from the smallest exposure parameter value up to a largest exposure parameter value, an exposure value of the pixel in the HDR video frame from a previously calculated exposure value of the pixel in the HDR video frame multiplied by a constant. The processor is additionally caused to calculate, for each pixel in the HDR video frame and for each exposure parameter value, an exposure value of the corresponding pixel in the version of the HDR video frame obtained following compression of the HDR video frame from a previously calculated exposure value of the corresponding pixel in the version of the HDR video frame obtained following compression of the HDR video frame multiplied by the constant. The processor is also caused to convert, for each pixel in the HDR video frame and for each exposure parameter value, the exposure value of the pixel in the HDR video frame into a low dynamic range, LDR, value for the pixel in the HDR video frame. The processor is further caused to convert, for each pixel in the HDR video frame and for each exposure parameter value, the exposure value of the corresponding pixel in the version of the HDR video frame obtained following compression of the HDR video frame into a LDR value for the corresponding pixel in the version of the HDR video frame obtained following compression of the HDR video frame. The processor is additionally caused to calculate, for each pixel in the HDR video frame and for each exposure parameter value, an error representing a difference between the LDR value for the pixel in the HDR video frame and the LDR value for the corresponding pixel in the version of the HDR video frame obtained following compression of the HDR video frame. The processor is also caused to calculate the evaluation measure based on the errors for all pixels in the HDR video frame and for all exposure parameter values.

A related aspect of the embodiments defines a carrier comprising a computer program as defined above. The carrier is one of an electronic signal, an optical signal, an electromagnetic signal, a magnetic signal, an electric signal, a radio signal, a microwave signal, or a computer-readable storage medium.

The present embodiments provide an evaluation measure that is adapted for HDR video frames. The evaluation measure can be calculated with an improved and fast implementation. Accordingly, the evaluation measure can be used during encoding and compression of HDR video.

### BRIEF DESCRIPTION OF THE DRAWINGS

The embodiments, together with further objects and advantages thereof, may best be understood by making reference to the following description taken together with the accompanying drawings, in which:

FIG. 1 is a flow chart illustrating a method for determining an evaluation measure according to an embodiment;

FIG. 2 schematically illustrates creating LDR versions of an original HDR video frame and of a version of the HDR video frame obtained following compression of the HDR video frame (reconstructed HDR video frame);

FIG. 3 is a flow chart illustrating additional, optional steps of the method shown in FIG. 1;

FIG. 4 is a diagram illustrating distribution of error weights for different exposure parameter values according to an embodiment;

FIG. 5 is a flow chart illustrating an embodiment of the calculation of the evaluation measure in FIG. 1;

FIG. 6 is a flow chart illustrating a method of encoding a HDR video frame according to an embodiment;

FIG. 7 is a schematic block diagram of an encoder according to an embodiment;

FIG. 8 is a schematic block diagram of an encoder according to another embodiment;

FIG. 9 is a schematic block diagram of an encoder according to a further embodiment;

FIG. 10 is a schematic block diagram of a user equipment according to an embodiment;

FIG. 11 is a schematic block diagram of an encoder according to yet another embodiment;

FIG. 12 is a schematic block diagram of an HDR video frame encoding device according to an embodiment; and

FIG. 13 is a schematic block diagram of a cloud-based implementation of embodiments.

### DETAILED DESCRIPTION

Throughout the drawings, the same reference numbers are used for similar or corresponding elements.

The present embodiments generally relate to evaluation measures for HDR video, and in particular such an evaluation measure that can be used in connection with encoding and compressing HDR video.

The evaluation measure of the embodiments can thereby be used, for instance, in connection with encoding and compression in order to compare various encoding or compression modes with each other and thereby selecting a most suitable encoding or compression mode for compressing a HDR video frame, also denoted HDR video image or HDR video picture in the art, or at least a portion of the HDR video frame. Accordingly, the encoding or compression mode that results in the best result as represented by the evaluation measure of the embodiments is selected to be used when encoding or compressing the HDR video frame or the at least a portion thereof.

The HDR video frame, for which an evaluation measure is determined as described herein, is preferably a frame, image or picture of a HDR video. HDR video generally has a greater dynamic range of luminosity than is possible with LDR or SDR video. The aim is to present the human eye with a luminance range that is more similar to that which, through the visual system, is familiar in everyday life. The human eye adjusts constantly to the broad dynamic changes ubiquitous in our environment. The brain continuously interprets this information so that most of us can see in a wide range of light conditions.

The two primary types of HDR video are computer renderings and video resulting from merging multiple LDR or SDR cameras. HDR video can also be acquired using special image sensors, like an oversampled binary image sensor.

Within graphics LDR or SDR video are typically represented by 8 bits per color component, i.e. 24 bits per pixel (bpp) when using the red, green, blue (RGB) color space. HDR video may correspondingly be represented by using a 16-bit floating-point number per color component, resulting in 48 bpp when using the RGB color space.

The evaluation measure may be used in connection with encoding HDR video in order to select suitable encoding or compression modes for the individual HDR video frames in the HDR video.

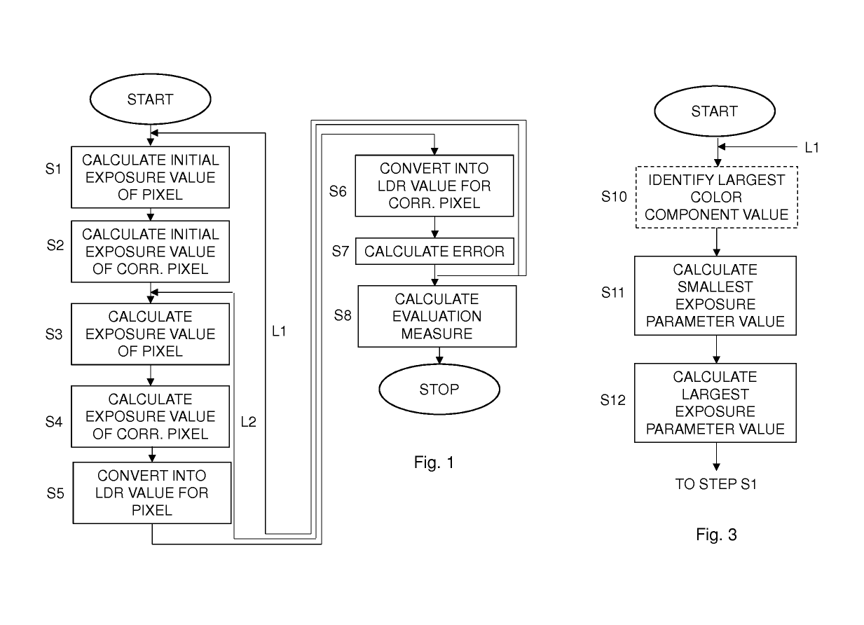

FIG. 1 is a flow chart illustrating a method for determining an evaluation measure for a high dynamic range (HDR) video frame. The method comprises performing the steps S1 to S7 for each pixel in the HDR video frame or in at least a portion of the HDR video frame that is to encoded or compressed, which is schematically represented by the line L1 in FIG. 1. Step S1 comprises calculating an initial exposure value of the pixel in the HDR video frame using a smallest exposure parameter value. Step S2 comprises calculating an initial exposure value of a corresponding pixel in a version of the HDR video frame obtained following compression of the HDR video frame. Steps S1 and S2 can be performed in any order or at least partly in parallel. The following steps S3 to S6 are performed for each exposure parameter value starting from the smallest exposure parameter value up to a largest exposure parameter value, which is schematically illustrated by the line L2 in FIG. 1. Step S3 comprises calculating, for the exposure parameter value, an exposure value of the pixel in the HDR video frame from a previously calculated exposure value of the pixel in the HDR video frame multiplied by a constant. Step S4 comprises calculating, for the exposure parameter value, an exposure value of the corresponding pixel in the version of the HDR video frame obtained following compression of the HDR video frame from a previously calculated exposure value of the corresponding pixel in the version of the HDR video frame obtained following compression of the HDR video frame multiplied by the constant. Step S5 comprises converting the exposure value of the pixel in the HDR video frame into a low dynamic range (LDR) value for the pixel in the HDR video frame. Step S6 comprises converting the exposure value of the corresponding pixel in the version of the HDR video frame obtained following compression of the HDR video frame into a LDR value for the corresponding pixel in the version of the HDR video frame obtained following compression of the HDR video frame. Steps S3 to S6 can be performed in any order or at least partly in parallel as long as step S5 is performed after step S3 and step S6 is performed after step S4. The following step S7 comprises calculating an error representing a difference between the LDR value for the pixel in the HDR video frame and the LDR value for the corresponding pixel in the version of the HDR video frame obtained following compression of the HDR video frame. The next step S8 comprises calculating the evaluation measure based on the errors for all pixels in the HDR video frame and for all exposure values.

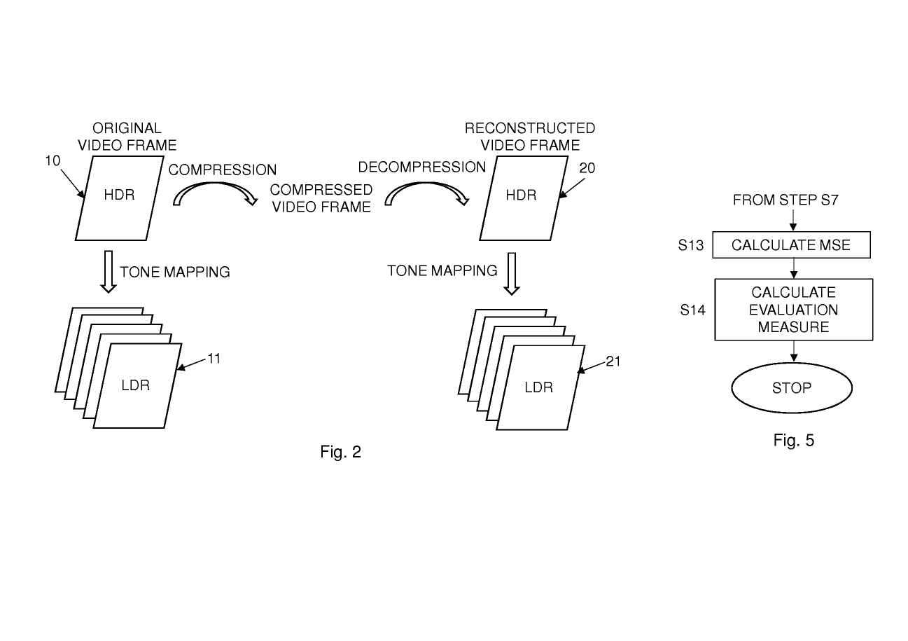

FIG. 2 schematically illustrates the relationship between an original HDR video frame 10 and the version 20 of the HDR video frame 10 obtained following compression of the HDR video frame 10. Thus, an original HDR video frame 10 is compressed or encoded according to a compression or encoding mode to obtain a compressed HDR video frame or encoded HDR video frame. The compressed or encoded HDR video frame is then decompressed or decoded in order to obtain the version 20 of the HDR video frame 10 obtained following compression of the HDR video frame 10, also referred to as a reconstructed HDR video frame 20 herein.

Generally, the compression or encoding process is lossy implying that the compressed or encoded HDR video frame is an inexact approximation for representing the frame content, i.e. the pixel or sample values, of the original HDR video frame 10. The reconstructed HDR video frame 20 obtained by decompression or decoding of the compressed or encoded HDR video frame is thereby a version or representation of the original HDR video frame 10 as processed through the compression-decompression/encoding-decoding procedure. Different compression and encoding modes will result in different compressed HDR video frames and different reconstructed HDR video frames 20 following decompression or decoding. The evaluation measure can thereby be used in order to select the “best” compression or encoding mode and thereby the “best” compressed or encoded HDR video frame for the original HDR video frame 10.

As is shown in FIG. 2, multiple LDR versions or so-called tone mapped versions 11, 21 are created for both the original HDR video frame 10 and for the reconstructed HDR video frame 20 in steps S5 and S6 of FIG. 1. This means that for a given original HDR video frame 10 multiple LDR versions 11 of the original HDR video frames 10 are obtained. Correspondingly, for the reconstructed HDR video frame 20 multiple LDR versions 21 of the reconstructed HDR video frame 20 are obtained. Respective such LDR versions 11, 21 are generated for each exposure parameter value ranging from the smallest exposure parameter value up to the largest exposure parameter value. Accordingly, if the range or set of exposure parameter values from the smallest exposure parameter value up to the largest exposure parameter consists of N≧2 exposure parameter values, then N LDR versions 11 of the original HDR video frame 10 and N LDR versions 21 of the reconstructed HDR video frame 20 are created in steps S5 and S6 and N errors are calculated in step S7 in FIG. 1.

The corresponding pixel in the version 20 of the HDR video frame 10 obtained following compression of the HDR video frame 10 preferably occupies the same pixel position within the version 20 of the HDR video frame 10 obtained following compression of the HDR video frame 10 as the current pixel occupies in the HDR video frame 10. Thus, if the current pixel occupies pixel position (x, y) within the HDR video frame 10 then the corresponding pixel occupies pixel position (x, y) in the reconstructed HDR video frame 20, i.e. in the version 20 of the HDR video frame 10 obtained following compression of the HDR video frame 10.

The present embodiments significantly simplify and speed up calculation of an evaluation measure that is suitable and adapted for HDR video and HDR video frames. This is possible by calculating initial exposure values of a pixel and of the corresponding pixel using a smallest exposure parameter value in steps S1 and S2. The exposure values for the pixel and the corresponding pixel are then calculated step-by-step as a function of a previously calculated exposure value for the pixel or the corresponding pixel multiplied by a constant. The previously calculated exposure value is preferably the immediately preceding exposure parameter value with regard to the exposure parameter. Thus, the step-by-step calculation in steps S3 and S4 goes through the set or range of exposure parameter values from the smallest exposure parameter (cₘᵢₙ) up to the largest exposure parameter value (cₘₐₓ).

In an embodiment, the calculation in step S1 and S2 is preferably performed using an exposure parameter value c equal to cₘᵢₙ−1. This in turn means that the loop of steps S3-S7 goes through Cε[cₘᵢₙ, cₘₐₓ]. An exposure parameter value of a pixel at pixel position (x, y) in the HDR video frame 10 as calculated in step S3 for a given exposure parameter value c, Rₚ^{c}(x, y), is then preferably calculated based on Rₚ^{c}(x, y)=Rₚ^{c-1}(x, y)×constant for cε[cₘᵢₙ, Cₘₐₓ].

This procedure of calculating exposure values of the pixels and of the corresponding pixels is computationally much more efficient as compared to directly calculating multiple LDR versions 11, 21 of the HDR video frame 10 and the reconstructed HDR video frame 20 using a tone mapping function as:

R_{LDR}^{C}(x,y)=clamp(0,255,round(255*(2^{c}*R_{HDR}(x,y))^{(1/γ)}))

G_{LDR}^{C}(x,y)=clamp(0,255,round(255*(2^{c}*G_{HDR}(x,y))^{(1/γ)}))

B_{LDR}^{C}(x,y)=clamp(0,255,round(255*(2^{c}*B_{HDR}(x,y))^{(1/γ)})),

wherein the triplet (R_{LDR}^{C}(x,y), G_{LDR}^{C}(x,y), B_{LDR}^{C}(x,y)) represents a LDR version of a pixel at pixel position within the HDR video frame 10 for exposure parameter value c and the triplet (R_{HDR}(x,y), G_{HDR}(x,y), B_{HDR}(x,y)) represent the original pixel value of the pixel, i.e. the original HDR value of the pixel.

The embodiments thereby provide a computationally much more efficient technique of calculating exposure values by calculating exposure values form a previous exposure value using a single multiplication as compared to a computationally expensive power function.

In the following various implementation embodiments of the method steps shown in FIG. 1 will be described in more detail.

In an embodiment, step S5 of FIG. 1 comprises converting the exposure value of the pixel in the HDR video frame into the LDR value using an addition of 0.5 and a casting operation.

In an embodiment, step S6 of FIG. 1 comprises converting the exposure value of the corresponding pixel in the version of the HDR video frame obtained following compression of the HDR video frame into the LDR value using an addition of 0.5, a min function and a casting operation.

A casting operation, also referred to as cast operation, type conversion or coercion in the art, typically involves changing an entity of one data type into another data type. An example of such a casting operation is to change a float number into an int number, i.e. changing a number from a floating point representation into an integer representation.

This means that the conversion of the exposure values into LDR values can be performed using computationally efficient operations. Accordingly, no power or logarithmic operations are needed and the number of conditional statements are minimized as compared to the above mentioned tone mapping function used to calculate LDR values.

Thus, in these embodiments the calculation of LDR values are performed in two steps for the pixels and the corresponding pixels. In the first step, the exposure values are calculated and then these are converted into LDR values as disclosed above. Such an approach significantly speeds up the calculation of the evaluation measure as compared to using a single calculation step for calculating LDR values from input HDR values.

In an embodiment, each pixel in the HDR video frame 10 comprises a red color component, a blue color component and a green color component. Thus, in this embodiment pixels in the HDR video frame 10 and thereby in the version 20 of the HDR video frame 10 obtained following compression of the HDR video frame 10, i.e. the reconstructed HDR video frame 20, have respective pixel values in terms of RGB colors. This should, however, merely be seen as an illustrative example of the embodiments. In general, each pixel in the HDR video frame 10 and each corresponding pixel in the reconstructed HDR video frame 20 comprises a pixel value in terms of a color triplet, i.e. three color components. In a general embodiment, these color components could be denoted first, second and third color component. The color components could be represented in various color formats or spaces traditionally used during HDR video frame encoding and decoding. Non-limiting, but illustrative, examples of such color formats include red, green, blue (RGB) and luminance and chrominance, i.e. one luminance component and two chrominance components. In the following, the embodiments will be further described and exemplified using RGB as color space. The embodiments, however, also include replacing the RGB color components with color components according to another color space, such as a luminance component and two chrominance components, for instance luminance, chrominance blue and chrominance red (YCbCr); luminance, chrominance green and chrominance orange (YCgCo), YUV, Lab, XYZ, etc.

FIG. 3 is a flow chart illustrating additional, optional steps of the method shown in FIG. 1. Step S11 comprises calculating the smallest exposure parameter value based on ceil(γ×log(0.5/255.0)/log(2)−log(colMax)/log(2)). Ceil(x) is an operation rounding x up, γ represents a display gamma, colMax represents a largest color component value of the red color component, the green color component and the blue color component of the pixel in the HDR video frame 10. Step S12 comprises calculating the largest exposure parameter value based on floor(γ×log(254.5/255.0)/log(2)−log(colMax)/log(2)). Floor(x) is an operation rounding x down. Steps S11 and S12 can be performed in any order or at least partly in parallel.

Thus, the smallest and largest exposure parameter values are calculated in steps S11 and S12 based on the largest color component of the current pixel in the HDR video frame. Hence, in an embodiment the method comprises an additional step S10 as shown in FIG. 3. This step S10 comprises identifying a largest color component of the red color component, the green color component and the blue color component of the pixel in the HDR video frame 10. This largest color component is then used in steps S11 and S12 in order to calculate the end points of the exposure parameter range, i.e. the smallest exposure parameter value and the largest exposure parameter value.

The display gamma γ used in steps S11 and S12 is preferably 2.2.

Gamma defines the relationship between a numerical value of a pixel and its actual luminance. Without gamma, representing the luminance as an integer between, say, 0 and 255 could be done using L=100×n/255, where L is the luminance in candela per square meter (cd/m²) and n the code value. However, that would give too big relative error for dark values and unnecessary small errors for bright values. As an example, when stepping from n=1 to n=2, the luminance would double from L(1)=100×1/255=0.3921 cd/m² to L(2)=100×2/255=0.7843, a relative difference of (0.7843−0.3921)/0.3921=100%. In the bright areas stepping from n=254 to n=255 would bring about a much lower relative difference, since L(254)=99.60 and L(255)=100, the relative difference becoming (100−99.60)/99.60=0.39%. Since the eye can be more sensitive to the relative error than to the absolute error, representing low dynamic range images using a linear function such as L=100×n/255 is not a good idea. Therefore, a LDR image is instead represented using a gamma function; L=100×(n/255)⁷, where γ is a positive value such as 2.2. Now n=20 gives a similar luminance value as n=1 gave before; L(20)=100×20/255)^{2.2}=0.3697 cd/m² which is close to 0.3921 cd/m². But now if we step one step to n=21 we get a luminance of L(21)=100×(21/255)^{2.2}=0.4116. The relative error is now (0.4116-0.3697)/0.3697=11.3% which is much smaller than 100%. This advantage is taken at the expense of the accuracy near 100 cd/m², the last two steps are L(254)=100×(254/255)^{2.2}=99.1393 and L(255)=100×(21/255)^{2.2}=100, which gives a relative error of (100−99.1393)/99.1393=0.87%.

In summary, using display gamma γ when converting an integer number to a luminance lowers the relative error substantially for dark luminances, at the cost of a small increase of the relative error for bright luminances, which is better attuned to how the human visual system perceives LDR images. Therefore LDR images are represented in gamma form and comparisons between two images are also often made between the gamma representations, rather than between the linear luminance values.

In an embodiment, step S1 of FIG. 1 comprises calculating the initial exposure value of the pixel in the HDR video frame 10 as:

rOrigProcessed=255.0×exp((1.0/γ)×log(1.0×twoToC×rOrig))

gOrigProcessed=255.0×exp((1.0/γ)×log(1.0×twoToC×gOrig))

bOrigProcessed=255.0×exp((1.0/γ)×log(1.0×twoToC×bOrig))

In this embodiment, rOrigProcessed represents an exposure value of a red color component of the pixel in the HDR video frame 10, gOrigProcessed represents an exposure value of a green color component of the pixel in the HDR video frame 10 and bOrigProcessed represents an exposure value of a blue color component of the pixel in said HDR video frame 10. The parameter twoToC=exp((cMin−1)×log(2.0)), wherein cMin represents the smallest exposure parameter value. rOrig represents the red color component of the pixel in the HDR video frame 10, gOrig represents the green color component of the pixel in the HDR video frame 10 and bOrig represents the blue color component of the pixel in the HDR video frame 10. The initial exposure value of the corresponding pixel in the version 20 of the HDR vide frame 10 obtained following compression of the HDR video frame 10 is preferably calculated in step S2 as:

rCopyProcessed=255.0×exp((1.0/γ)×log(1.0×twoToC×rCopy))

gCopyProcessed=255.0×exp((1.0/γ)×log(1.0×twoToC×gCopy))

bCopyProcessed=255.0×exp((1.0/γ)×log(1.0×twoToC×bCopy))

In this embodiment, rCopyProcessed represents an exposure value of a red color component of the corresponding pixel in the version 20 of the HDR video frame 10 obtained following compression of the HDR video frame 10, gCopyProcessed represents an exposure value of a green color component of the corresponding pixel in the version 20 of the HDR video frame 10 obtained following compression of the HDR video frame 10 and bCopyProcessed represents an exposure value of a blue color component of the corresponding pixel in the version 20 of the HDR video frame 10 obtained following compression of the HDR video frame 10. rCopy represents the red color component of the corresponding pixel in the version 20 of the HDR video frame 10 obtained following compression of the HDR video frame 10, gCopy represents the green color component of the corresponding pixel in the version 20 of the HDR video frame 10 obtained following compression of the HDR video frame 10 and bCopy represents the blue color component of the corresponding pixel in the version 20 of the HDR video frame 10 obtained following compression of the HDR video frame 10.

rOrig, gOrig and bOrig, thus represent the original HDR pixel values for the pixel in the HDR video frame 10, whereas rCopy, gCopy and bCopy represents the original HDR pixel values for the corresponding pixel in the reconstructed HDR video frame 20.

In an embodiment, calculating the exposure value of the pixel in the HDR video frame 10 in step S3 comprises calculating, for each exposure parameter value starting from the smallest exposure parameter value up to the largest exposure parameter value:

rOrigProcessed×=factor

gOrigProcessed×=factor

bOrigProcessed×=factor

In this embodiment, the constant factor=exp((1.0/γ)×log(2.0)). The exposure value of the corresponding pixel in the version 20 of the HDR video frame 10 obtained following compression of the HDR video frame 10 is preferably calculated in step S4 and for each exposure parameter value starting from the smallest exposure parameter value up to the largest exposure parameter value as:

rCopyProcessed×=factor

gCopyProcessed×=factor

bCopyProcessed×=factor

The notation “a×=b” as used herein corresponds to the operation a=a×b, thus the parameter a is updated by multiplying the parameter a with the parameter b.

Hence, in this embodiment the constant used to multiply the previously calculated exposure value of the pixel or the corresponding pixel is preferably dependent on the display gamma, i.e. exp((1.0/γ)×log(2.0)). This corresponds to calculating a color component Rₚ for a pixel at pixel position (x, y) in the HDR video frame 10 and for current value of the exposure parameter c as Rₚ^{c}(x, y)=Rₚ^{c-1}(x, y)×factor.

In an embodiment, converting the exposure value of the pixel in the HDR video frame 10 in step S5 comprises calculating:

LDRorigR=(int)(rOrigProcessed+0.5)

LDRorigG=(int)(gOrigProcessed+0.5)

LDRorigB=(int)(bOrigProcessed+0.5)

In this embodiment, LDRorigR represents a LDR value of a red color component of the pixel in the HDR video frame 10, LDRorigG represents a LDR value of a green color component of the pixel in the HDR video frame 10 and LDRorigB represents a LDR value of a blue color component of the pixel in the HDR video frame 10. (int) represents a casting operation. This embodiment of a casting operation outputs the LDR values of the red, green and blue color components as integer LDR values.

In this embodiment, converting the exposure value of the corresponding pixel in the version 20 of the HDR video frame 10 obtained following compression of the HDR video frame 10 in step S6 preferably comprises calculating:

LDRcopyR=(int)dMin(rCopyProcessed+0.5,255.5)

LDRcopyG=(int)dMin(gCopyProcessed+0.5,255.5)

LDRcopyB=(int)dMin(bCopyProcessed+0.5,255.5)

In this embodiment, LDRcopyR represent a LDR value of a red color component of the corresponding pixel in the version 20 of the HDR video frame 10 obtained following compression of the HDR video frame 10, LDRcopyG represent a LDR value of a green color component of the corresponding pixel in the version 20 of the HDR video frame 10 obtained following compression of the HDR video frame 10 and LDRcopyB represent a LDR value of a blue color component of the corresponding pixel in the version 20 of the HDR video frame 10 obtained following compression of the HDR video frame 10. dMin(x, y) represents a min function implemented as: if (x>y) return y, else return x.

In a first embodiment, calculating the error in step S7 comprises calculating the error as:

(LDRorigR−LDRcopyR)×(LDRorigR−LDRcopyR)+(LDRorigG−LDRcopyG)×(LDRorigG−LDRcopyG)+(LDRorigB−LDRcopyB)×(LDRorigB−LDRcopyB).

In a second embodiment, calculating the error in step S7 comprises calculating the error as:

|LDRorigR−LDRcopyR|+|LDRorigG−LDRcopyG|+|LDRorigB−LDRcopyB|.

In a third embodiment, calculating the error in step S7 comprises calculating the error as:

w_{R}×(LDRorigR−LDRcopyR)×(LDRorigR−LDRcopyR)+w_{G}×(LDRorigG−LDRcopyG)×(LDRorigG−LDRcopyG)+w_{B}×(LDRorigB−LDRcopyB)×(LDRorigB−LDRcopyb).

In a fourth embodiment, calculating the error in step S7 comprises calculating the error as:

w_{R}×|LDRorigR−LDRcopyR|+w_{G}×|LDRorigG−LDRcopyG|+w_{B}×|LDRorigB−LDRcopyB|.

In these embodiments, w_{R}, w_{G}, w_{B} are weights.

The first and second embodiments above could be seen as particular implementation examples of the third and fourth embodiments by using the same weights equal to one for the three color components. The third and fourth embodiment are more general by allowing different weights for the different color components when calculating the error in step S7. It is also possible in the third and fourth embodiments to use different weights for different loops of the steps S3 to S7, represented by the line L2 in FIG. 1. This corresponds to using different weights for different exposure parameter values. Hence, in particular embodiment the weights w_{R}, w_{G}, w_{B} are determined based on the exposure parameter value c, i.e. w_{R}=f_{R}(c), w_{G}=f_{G}(c) and w_{B}=f_{B}(c) for some defined functions f_{R}(.), f_{G}(.) and f_{B}(.).

The first and second embodiments above have a tendency to amplify dark noise when calculating the evaluation measure. The third and fourth embodiment can suppress such dark noise by using different weights for different exposure parameter values and/or for different color components.

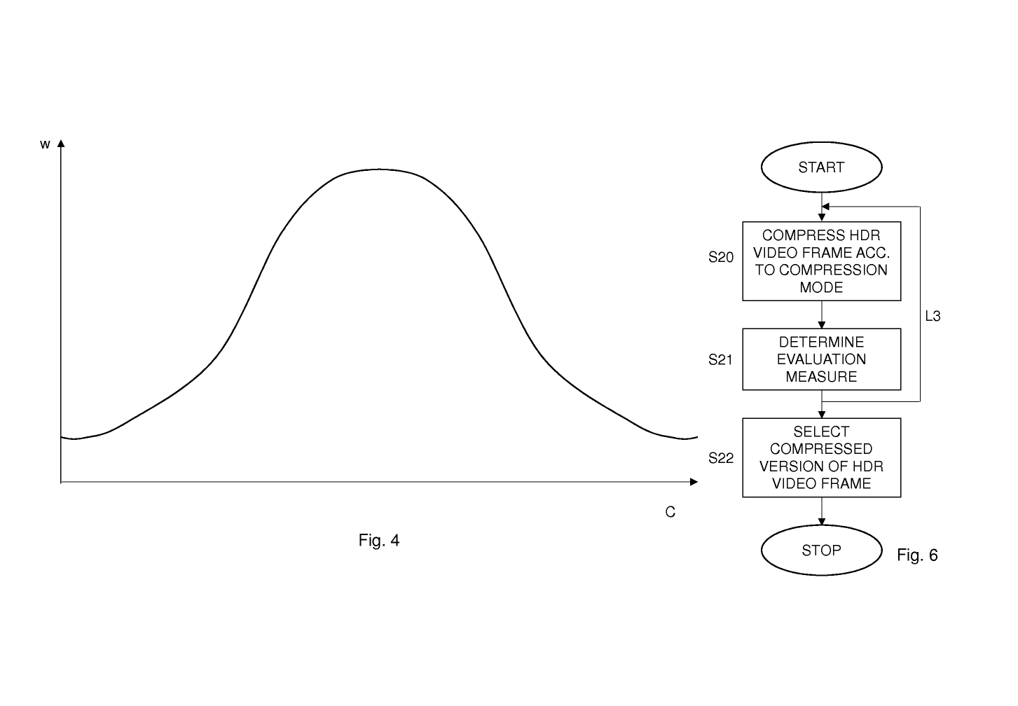

FIG. 4 is a diagram illustrating distribution of weights for different exposure parameter values according to an embodiment. In this particular embodiment, lower weights w_{R}, w_{G}, w_{B} are generally used for low values of the exposure parameter and for high values of the exposure parameter as compared to mid-range values of the exposure parameter.

In an embodiment, w_{R}=w_{G}=w_{B}=f(c). This means that the same weights are used for all three color components and the value of the weight is dependent on the exposure parameter value, such as shown in FIG. 4. In another embodiment, the separate weights may be used for at least two of or all three color components. Then each such weight may be determined as a given function of the exposure parameter value as mentioned above. In such a case, each color component could have a respective distribution of weights for different exposure parameter values.

If weights are not used, a small change in a dark pixel may contribute a lot to the final value of the evaluation measure. Assume for example two pixels in the HDR video frame, a first pixel where the original HDR RGB-value equals (0.3, 0.3, 0.3) and a pixel with original HDR RGB-value equals (3000, 3000, 3000). Assume that, after compression and decompression, the reconstructed HDR RGB-values for the two pixels become (0.6, 0.6, 0.6) and (3300, 3300, 3300), respectively. The smallest and largest exposure parameter values for the first pixel will be c=−18 and c=1, respectively. If we calculate the LDR values for the 20 exposures we will get the following errors:

| | | | | sum |
|---|---|---|---|---|
| | | | | squared |
| c | LDRorig(R, G, B) | LDRcopy(R, G, B) | difference | error |
| −18 | (1, 1, 1) | (1, 1, 1) | (0, 0, 0) | 0 |
| −17 | (1, 1, 1) | (1, 1, 1) | (0, 0, 0) | 0 |
| −16 | (1, 1, 1) | (1, 1, 1) | (0, 0, 0) | 0 |
| −15 | (1, 1, 1) | (2, 2, 2) | (1, 1, 1) | 3 |
| −14 | (2, 2, 2) | (2, 2, 2) | (0, 0, 0) | 0 |
| −13 | (2, 2, 2) | (3, 3, 3) | (1, 1, 1) | 3 |
| −12 | (3, 3, 3) | (5, 5, 5) | (2, 2, 2) | 12 |
| −11 | (5, 5, 5) | (6, 6, 6) | (1, 1, 1) | 3 |
| −10 | (6, 6, 6) | (9, 9, 9) | (3, 3, 3) | 27 |
| −9 | (9, 9, 9) | (12, 12, 12) | (3, 3, 3) | 27 |
| −8 | (12, 12, 12) | (16, 16, 16) | (4, 4, 4) | 48 |
| −7 | (16, 16, 16) | (22, 22, 22) | (6, 6, 6) | 108 |
| −6 | (22, 22, 22) | (31, 31, 31) | (9, 9, 9) | 243 |
| −5 | (31, 31, 31) | (42, 42, 42) | (11, 11, 11) | 363 |
| −4 | (42, 42, 42) | (57, 57, 57) | (15, 15, 15) | 675 |
| −3 | (57, 57, 57) | (79, 79, 79) | (22, 22, 22) | 1452 |
| −2 | (79, 79, 79) | (108, 108, 108) | (29, 29, 29) | 2523 |
| −1 | (108, 108, 108) | (148, 148, 148) | (40, 40, 40) | 4800 |
| 0 | (148, 148, 148) | (202, 202, 202) | (54, 54, 54) | 8748 |
| 1 | (202, 202, 202) | (255, 255, 255) | (53, 53, 53) | 8427 |

If we sum up the right most column, the total error contributed by the first pixel is, thus, 27462.

Meanwhile, the exposure parameter values for the second pixel will be c=−31 to c=−12. A similar table for this second pixel will look as follows:

| | | | | sum |
|---|---|---|---|---|
| | | | | squared |
| c | LDRorig(R, G, B) | LDRcopy(R, G, B) | difference | error |
| −31 | (1, 1, 1) | (1, 1, 1) | (0, 0, 0) | 0 |
| −30 | (1, 1, 1) | (1, 1, 1) | (0, 0, 0) | 0 |
| −29 | (1, 1, 1) | (1, 1, 1) | (0, 0, 0) | 0 |
| −28 | (1, 1, 1) | (1, 1, 1) | (0, 0, 0) | 0 |
| −27 | (2, 2, 2) | (2, 2, 2) | (0, 0, 0) | 0 |
| −26 | (3, 3, 3) | (3, 3, 3) | (0, 0, 0) | 0 |
| −25 | (4, 4, 4) | (4, 4, 4) | (0, 0, 0) | 0 |
| −24 | (5, 5, 5) | (5, 5, 5) | (0, 0, 0) | 0 |
| −24 | (7, 7, 7) | (7, 7, 7) | (0, 0, 0) | 0 |
| −22 | (9, 9, 9) | (10, 10, 10) | (1, 1, 1) | 3 |
| −21 | (13, 13, 13) | (14, 14, 14) | (1, 1, 1) | 3 |
| −20 | (18, 18, 18) | (19, 19, 19) | (1, 1, 1) | 3 |
| −19 | (24, 24, 24) | (25, 25, 25) | (1, 1, 1) | 3 |
| −18 | (33, 33, 33) | (35, 35, 35) | (2, 2, 2) | 12 |
| −17 | (46, 46, 46) | (48, 48, 48) | (2, 2, 2) | 12 |
| −16 | (63, 63, 63) | (66, 66, 66) | (3, 3, 3) | 27 |
| −15 | (86, 86, 86) | (90, 90, 90) | (4, 4, 4) | 48 |
| −14 | (118, 118, 118) | (123, 123, 123) | (5, 5, 5) | 75 |
| −13 | (162, 162, 162) | (169, 169, 169) | (7, 7, 7) | 147 |
| −12 | (221, 221, 221) | (231, 231, 231) | (10, 10, 10) | 300 |

If we now sum up the right most column, we see that the total error contributed by this pixel is 633. Thus, the first pixel will contribute with a much larger error (27462) than the second pixel (633) to the evaluation measure. However, if we have a look at the HDR pixel values, the error is much larger in the second pixel:

| pixel | HDRorig(R, G, B) | HDRcopy(R, G, B) | difference | relative error |
|---|---|---|---|---|
| 1 | (0.3, 0.3, 0.3) | (0.6, 0.6, 0.6) | (0.3, 0.3. 0.3) | (1, 1, 1) |
| 2 | (3000, 3000, 3000) | (3300, 3300, 3300) | (300, 300, 300) | (0.1, 0.1, 0.1) |

In the first pixel, the error is 0.3 in each component. However, in the second pixel, the error is 300 in each component. Typically an error of 300 cd/m² is easier to see than an error of 0.3 cd/m², yet the first pixel contributes more to the evaluation measure as compared to the second pixel in this example. This means that it may be advantageous to weight the contribution from the first pixel with a first weight, and the contribution from the second pixel with a second weight, the second weight being larger than the first weight.

One way to achieve this is to have one weight per exposure parameter c. As an example, when c=−12, (which is available in both tables), the weight may be w(−12)=100. This means that the sum squared error of 12 for the first pixel will be multiplied by 100 to become 1200, and the sum squared error 300 for the second pixel will be multiplied by 100 to become 30000. However, the weight when c=−13 may be bigger, say w(−13)=110. The sum squared error at that level for the first pixel, 3, will be multiplied by 110 to become 330. At the same time, the sum squared error at that level for the second pixel, 147, will be multiplied by 110 to become 16170. By having a larger weight for small values of c, we can make sure that the error value for the second pixel will produce a significant contribution to the evaluation measure. As an example, the weight for c=−31 may be very big, and this will only be used in second pixel.

Note, however, that the relative error is actually smaller for the first pixel. This is the reason why the first pixel will contribute more to the error measure than the second pixel if using an unweighted error measure.

FIG. 5 is a flow chart illustrating an embodiment of the calculating step S8 in FIG. 1. In this embodiment, the method continues from step S7 in FIG. 1. A following step S13 comprises calculating a mean squared error (MSE) as an average error for all pixels in the HDR video frame and for all exposure values. The method then continues to step S14, which comprises calculating the evaluation measure based on the mean squared error.

In an embodiment, calculating the evaluation measure in step S14 comprises calculating the evaluation measure as a peak signal-to-noise ratio of the mean squared error as:

10×log((255×255)/MSE)/log(10)

In this embodiment, MSE represents the mean squared error.

The embodiments relate to an evaluation measure, denoted mPSNR herein, which can be used for evaluation of HDR video frames. In short, for each HDR video frame, several LDR versions, such as in the form of virtual photographs or tone mapped versions with different virtual shutter speeds, i.e. exposure parameter values, are created, and then PSNR measures are calculated for these LDR versions. The mPSNR value is an aggregate of these PSNR measures.

The range of exposure parameter values c is preferably limited. The reason for this is that for small values of c (large negative values), most pixels will become black (0,0,0), and therefore the MSE will be small for those pixels. This gives an impression that the compression is artifact free, which is not necessarily the case. In reality, those pixels do not carry any information, and their exclusion thus makes the measure better. Likewise for values that are bigger than 255, most values will become white (255, 255, 255) when c is large enough, and this also give the erroneous impression that the compression is artifact free.

Also, if you have a very large value in one component, and small in the other components, such as (4000, 1, 2), it will be hard for the human eye to tell the difference between this and, say (4000, 2, 2), which might be the compressed result. But with a large enough c number, (4000, 1, 2) will be mapped to, for instance, (255, 90, 180), whereas the compressed result (4000, 2, 2) will be mapped to (255, 180, 180). This will result in a huge error in the green component, whereas this is likely not visible in the actual pixel. Hence, it makes sense to remove this pixel from the calculation, which is done in the proposed method since the red component has saturated to 255.

The original, un-optimized version of the code can be explained as follows:

```
sse=0
for all exposures from c=−34 to 15
  for all pixels in an image
    calculate LDRredOrig, LDRgreenOrig, LDRblueOrig from
    HDR R, G, B of original
    calculate LDRredCopy, LDRgreenCopy, LDRblueCopy from
    HDR R, G, B of copy
    if pixel is not saturated
      sse += (LDRredOrig−LDRredCopy)²
      sse += (LDRgreenOrig−LDRgreenCopy)²
      sse += (LDRblueOrig−LDRblueCopy)²
      numpixels++;
    end
  end
end
mse = sse/(3.0*numpixels)
mPSNR = PSNR = 10*log((255*255)/mse)/log(10);
```

In this un-optimized version, a fixed set or range of exposure parameter values [−34, 15] is used. This generally leads to an inefficient computation of the evaluation measure mPSNR, which is further described herein.

To calculate LDRredOrig from the original HDR floating point value R is done in the following manner:

R_{LDR}^{C}(x,y)=clamp(0,255,round(255*(2^{c}*R_{HDR}(x,y))^{(1/γ)}))

where we have used LDRredOrig=R_{LDR}^{c}. Corresponding expressions apply for the other two color components. If we look at the innermost value 255*(2^{c}*R_{HDR}(x,y))^{(l/γ)} this consists of two power functions x^{p}. First 2^{c} (p being c) and then (R_{HDR}(x,y))^{(1/γ)} (p being 1/γ). Such power functions are typically implemented using a logarithm: x^{p}=exp(ln(x^{p}))=exp(p*ln(x)). Since both the exponent function exp(.) and the logarithm ln(.) are expensive in terms of computation, this is a very expensive operation. Thus, one goal of the optimizations is therefore to avoid these expensive computations.

It should be noted that not all LDRredOrig values influence the end result; only if it passes the saturation test does this value influence the variable sse. The saturation test is as follows:

```
if LDRredOrig==0 AND LDRgreenOrig==0 AND LDRblueOrig==0
  return false:
else if LDRredOrig==255 OR LDRgreenOrig==255 OR
LDRblueOrig==255
  return false
else
  return true
end
```

Now, if we study the expression for LDRredOrig again,

R_{LDR}^{C}(x,y)=clamp(0,255,round(255*(2^{c}*R_{HDR}(x,y))^{(1/γ)}))

we notice that this value will equal 255 if the value 255*(2^{c}*R_{HDR}(x,y))^{(1/γ)} is larger than 254.5 since it will be rounded to 255. In this case, the pixel will be saturated and will not be used. This is equivalent with c being larger than cMax=γ ln(254.5/255)/ln(2)−ln(R_{HDR}(x,y))/ln(2). Note that c loops over all values between −34 and 15, including 15. But as soon as we come to a c value that is larger than cMax for a certain pixel we know that all larger c values will not contribute to the sse of that pixel. In fact we only have to look at the largest of the three color components R, G and B. The largest one will determine the maximum value of c that will influence the calculations.

Likewise, it is not necessary to look at c values that are so low that all components become zero, since this will also be counted as a saturated pixel. When c is so small that even the largest component will result in a value smaller than 0.5, which will be quantized to 0. We know it will not influence the computation.

Hence, for a certain pixel, we can loop from cMinInt to cMaxInt, i.e. from the smallest exposure parameter value to the largest exposure parameter value, instead of from −34 to 15. This saves a lot of computation, since cMaxInt−cMinInt is typically around 20 instead of 50. For this to work we have to reverse the order of the for-loops. In summary we can use:

```
sse=0
for all pixels in an image
  colMax=max(R, G, B) of original
  cMinInt = ceil(gamma * log(0.5/255.0)/log(2) − log(colMax)/log(2);
  cMaxInt = floor(gamma * log(254.5/255.0)/log(2) − log(colMax)/
  log(2);
  for c=cMinInt to cMaxInt
    calculate LDRredOrig, LDRgreenOrig, LDRblueOrig from
    HDR R, G, B of original
    calculate LDRredCopy, LDRgreenCopy, LDRblueCopy from
    HDR R, G, B of copy
    sse += (LDRredOrig−LDRredCopy)²
    sse += (LDRgreenOrig−LDRgreenCopy)²
    sse += (LDRblueOrig−LDRblueCopy)²
    numpixels++;
  end
end
mse = sse/(3.0*numpixels)
mPSNR = PSNR = 10*log((255*255)/mse)/log(10);
```

Here floor(x) rounds x down and ceil(x) rounds x up. Note that the test for saturation is no longer needed since we know that none of the pixels saturate.

Even with these optimizations, it still takes considerable time to calculate the evaluation measure. The bulk of the computation comes from the calculation of LDRredOrig, LDRgreenOrig, etc., which is why we will have a look at this again. The expression

```
R_{LDR}^{C}(x,y).clamp(0,255,round(255*(2^{c}*R_{HDR}(x,y))^{(1/γ)}))
can be calculated in two steps;
  R_{P}^{C}(x,y)=255*(2^{c}*R_{HDR}(x,y))^{(1/γ)},
and
  R_{LDR}^{C}(x,y)=clamp(0,255,round(R_{P}^{C}(x,y))).
```

If we look at the first step, we see that this can be rewritten as

R_{P}^{C}(x,y)=255*(2^{c}*R_{HDR}(x,y))^{(1/γ)}=255*(2^{c})^{(1/γ)}*(R_{HDR}(x,y))^{(1/γ)}=255*(R_{HDR}(x,y))^{(1/γ)}*(2^{(1/γ)})^{c}.

But this can be further simplified to

255*(R_{HDR}(x,y))^{(1/γ)}*(2^{(1/γ)})^{(c-1)}*(2^{(1/γ)})=R_{P}^{C-1}(x,y)*(2^{(1/γ)}).

Note also that (2^{(1/γ)}) is a constant. Hence in order to get R_{P}^{C}(x,y), we just multiply the previous value R_{P}^{C-1}(x,y) with this constant.

According to the present invention, we can therefore rewrite the method as follows:

```
sse=0
for all pixels in an image
  colMax=max(R, G, B) of original
  cMinInt = ceil(gamma * log(0.5/255.0)/log(2) − log(colMax)/log(2);
  cMaxInt = floor(gamma * log(254.5/255.0)/I2 − log(colMax)/log(2);
  twoToC = exp((cMinInt−1)*log(2));
  factor = exp(inverseGamma*log(2));
  rOrigP = 255.0 * exp( inverseGamma * log( (( (twoToC))*rOrig) ) );
  gOrigP = 255.0 * exp( inverseGamma * log( (( (twoToC))*gOrig) ) );
  bOrigP = 255.0 * exp( inverseGamma * log( (( (twoToC))*bOrig) ) );
  rCopyP = 255.0 * exp( inverseGamma * log( (( (twoToC))*rCopy) ) );
  gCopyP = 255.0 * exp( inverseGamma * log( (( (twoToC))*gCopy) ) );
  bCopyP = 255.0 * exp( inverseGamma * log( (( (twoToC)) *bCopy) ) );
  for c=cMinInt to cMaxInt
    rOrigP *= factor
    gOrigP *= factor
    bOrigP *= factor
    rCopyP *= factor
    gCopyP *= factor
    bCopyP *= factor
    LDRredOrig = round(clamp(0, 255, rOrigP))
    LDRdreenOrig = round(clamp(0, 255, dOrigP))
    LDRblueOrig = round(clamp(0, 255, bOrigP))
    LDRredCopy = round(clamp(0, 255, rCopyP))
    LDRdreenCopy = round(clamp(0, 255, gCopyP))
    LDRblueCopy = round(clamp(0, 255, bCopyP))
    sse += (LDRredOrig−LDRredCopy)²
    sse += (LDRgreenOrig−LDRgreenCopy)²
    sse += (LDRblueOrig−LDRblueCopy)²
    numpixels++;
  end
end
mse = sse/(3.0*numpixels)
mPSNR = PSNR = 10*log((255*255)/mse)/log(10);
```

This program has exchanged the calculation of LDRredOrig in the inner loop with the underlined code. Note that it avoids any expensive exp(.) and log(.) functions. Instead it is replaced by a simple floating point multiplication, which on many architectures can be executed in a single clock cycle. This value is then rounded and clamped to produce the LDR value LDRredOrig further down in the underlined code. We have also added code before the loop, the eight lines before the for-loop starting with twoToC=, which is italicized. These lines are needed to create starting values used to calculate subsequent exposure values. These lines make use of the expensive exp(.) and log(.) functions. However, since they are outside the loop they do not contribute so much to the computation lines as the lines inside the loop.

This embodiment results in a substantial reduction in computation time compared to the original, un-optimized version of the code presented in the foregoing. Compared to that un-optimized code, the execution times is reduced from around 14 seconds to 3.7 seconds per HDR video frame, a speedup of around 3.8×.

However, there is more speedup possible. Most of the time is typically spent in the inner loop. If we look at the inner loop now, it consists only of quite simple arithmetical operations; multiplications, subtractions and additions of floating point and integer data. The exception is in the rounding and clamping operations. These consist of if-statements, which are typically detrimental to fast execution, since they create bubbles in the execution pipeline of the CPU when the CPU guesses wrong in the branch prediction. As an example, the clamp operation is often implemented as

```
if( x > 255.0)
  x = 255.0;
else if( x < 0.0)
  x = 0.0;
end;
```

This creates two if statements. In both cases the CPU will guess the most likely outcome and when it guesses wrongly, it will have to flush the pipeline causing a penalty of several clock cycles.

However, according to an embodiment of the invention, we draw attention to the fact there is typically a clamping step, i.e. clipping step, for the values of the original and compressed versions of the image before comparisons begin. The input, i.e. the original and compressed images, represents linear light and since light cannot be negative, it makes sense to clamp negative values to zero, i.e. replacing negative values with 0. Likewise, since 65504 is the largest representable value in half-float, it makes sense to clamp values larger than 65504, such as infinitives, to 65504. This has typically been done by inserting the following code shown in bold:

```
sse=0
for all pixels in an image
  rOrig = clamp(0, 65504, RHDRorig)
  gOrig = clamp(0, 65504, GHDRorig)
  bOrig = clamp(0, 65504, BHDRorig)
  rCopy = clamp(0, 65504, RHDRcopy)
  gCopy = clamp(0, 65504, GHDRcopy)
  bCopy = clamp(0, 65504, BHDRcopy)
  colMax=max(R, G, B) of original
  cMinInt = ceil(gamma * log(0.5/255.0)/log(2) − log(colMax)/log(2);
  cMaxInt = floor(gamma * log(254.5/255.0)/I2 − log(colMax)/log(2);
  . . .
```

where clamp(a, b, x), also written fClip(a, b, x), replaces values smaller than a with a, replaces values larger than b with b and does not change values between a and b. In the present invention, we make use of this fact by realizing that this means that the exposure values R_{P}^{C}(x,y) can never be negative. To see this, note that since

R_{P}^{C}(x,y)=255*(2^{c}*R_{HDR}(x,y))^{(1/γ)},

where R_{HDR}(x,y) represents the rOrig value in the pseudo-code above, the smallest value that R_{P}^{C}(x,y) can take is 255*(2^{c}*0)^{(1/γ)} which equals 0. Hence we can never have negative values of R_{P}^{C}(x,y) and it is unnecessary to test against negative values in the clamping comparison. We can hence replace the last six underlined lines with

LDRredOrig = round(min(255, rOrigP))
LDRgreenOrig = round(min(255, gOrigP))
LDRblueOrig = round(min(255, bOrigP))
LDRredCopy = round(min(255, rCopyP))
LDRgreenCopy = round(min(255, gCopyP))
LDRblueCopy = round(min(255, bCopyP)).

Since min(x,y) is typically implemented as

```
if( x>y)
  return y
else
  return x
```

This is one less if-statement as compared to the clamp-operation it replaces, which leads to quicker execution. Thus, according to one aspect of the invention, the exposure value rCopyP is converted to an LDR-value using a min-operation followed by rounding. This part of the invention hinges on the fact that the values have already been pre-clamped as described in the bold pseudo-code above, and this also takes time. However, this pre-clamping only happens once per pixel and is, thus, less time consuming than the clamping of the exposure values which happens every time in the inner loop, which is up to 20 times more often.

In a further embodiment of the invention we draw attention to the fact that the c-values are calculated in a way that ensures that that no processed value of the original ever exceeds 254.5, see above. This means that it is unnecessary to test it against 255 as well. This does not apply to the copy. Hence we can replace the above with the even simpler

LDRredOrig = round(rOrigP)
LDRgreenOrig = round(gOrigP)
LDRblueOrig = round(bOrigP)
LDRredCopy = round(min(255, rCopyP))
LDRgreenCopy = round(min(255, gCopyP))
LDRblueCopy = round(min(255, bCopyP)).

This further reduces the amount of if-statements that the CPU needs to execute and it again results in a speedup.

In yet another embodiment, we turn to the fact that a round(.) operation is typically implemented as follows:

```
if( x>=0)
  return (int)(x+0.5)
else
  return (int)(x−0.5)
```

This results in another if statement that will slow down execution. However, we have already realized that R_{P}^{C}(x,y) can never be smaller than zero. Hence the round(.) operation can simply be replaced by (int)(x+0.5) and the above code can be further simplified to

LDRredOrig = (int)(rOrigP+0.5)
LDRgreenOrig = (int)(gOrigP+0.5)
LDRblueOrig = (int)(bOrigP+0.5)
LDRredCopy = (int)(min(255.5, rCopyP+0.5))
LDRgreenCopy = (int)(min(255.5, gCopyP+0.5))
LDRblueCopy = (int)(min(255.5, bCopyP+0.5)).

As mentioned previously, in the exemplified embodiments the red component R is used to exemplify a color space but a person skilled in the art would realize that the embodiments are also valid for green G and blue B as well as for other color spaces, such as YCbCr, YUV, Lab, XYZ, etc.

Thus, according one aspect of the invention, the exposure value, rOrigP, is converted to an LDR-value, LDRredOrig, using only an addition of 0.5 and casting operation, see top three rows.

Furthermore, according to another aspect of the invention, the exposure value, rCopyP, is converted to an LDR-value, LDRredCopy, using an addition, a min-operation and a casting operation, see bottom three rows.

On some architectures, it may be quicker to multiply a floating point number by two instead of adding 0.5. In this case it is possible to use

LDRredOrig = (((int)(2*rOrigP))+1)>>1
LDRgreenOrig = (((int)(2*gOrigP))+1)>>1
LDRblueOrig = (((int)(2*bOrigP))+1)>>1
LDRredCopy = (((int)(min(551, 2*rCopyP)))+1)>>1
LDRgreenCopy = (((int)(min(551, 2*gCopyP)))+1)>>1
LDRblueCopy = (((int)(min(551, 2*bCopyP)))+1)>>1

where >> indicates bit shift.

Finally, instead of increasing numpixel with one every turn of the loop, we can add cMaxInt-cMinInt+1 to numpixel outside the loop. This saves yet computation time. With all these embodiments combined, the resulting execution time is 1.97 seconds per HDR video frame. Compared to the variant described in the foregoing, which executes in 14 seconds, this is a speedup of 7.1x.

Below follows a C++ implementation of the embodiments:

```
double DistortionMetricmPSNRfast::calculateErrorRGB(Frame* inp0, Frame* inp1)
{
  static const double gamma = 2.20;
  static const double inverseGamma = 1.0 / gamma;
  double sse = 0.0;
  int numPixels = 0;
  int width×height = inp0->m_compSize[R_COMP];
  float *inp0Comp0 = inp0->m_floatComp[0];
  float *inp0Comp1 = inp0->m_floatComp[1];
  float *inp0Comp2 = inp0->m_floatComp[2];
  float *inp1Comp0 = inp1->m_floatComp[0];
  float *inp1Comp1 = inp1->m_floatComp[1];
  float *inp1Comp2 = inp1->m_floatComp[2];
  m_sse[R_COMP] = 0.0;
  m_sse[G_COMP] = 0.0;
  m_sse[B_COMP] = 0.0;
  for(int x = 0; x < width×height; x++) {
    // First calculate the lowest possible c.
    // Make sure neither original nor compressed pixel is below 0 or higher than 65504.
    // Max value for half is 65504. Infs will be clipped to 65504.
    float rOrig = fClip(inp0Comp0[x], 0.0f, 65504.0f);
    float gOrig = fClip(inp0Comp1[x], 0.0f, 65504.0f);
    float bOrig = fClip(inp0Comp2[x], 0.0f, 65504.0f);
    float rCopy = fClip(inp1CompO[x], 0.0f, 65504.0f);
    float gCopy = fClip(inp1Comp1[x], 0.0f, 65504.0f);
    float bCopy = fClip(inp1Comp2[x], 0.0f, 65504.0f);
    // Get the biggest color component.
    double colMax = dMax(bOrig, dMax(rOrig, gOrig));
    // Calculate the first value that will give a contribution.
    // This happens 255*(2\hat{ }c* colMax)\hat{ }(1/gamma) is exactly 0.5,
    // which is equivalent to cMin = gamma*log(0.5/255)/log(2) − log(colMax)/log(2).
    double I2 = log(2.0);
    double cMin = 2.2 * log(0.5/255.0)/I2 − log(colMax)/12;
    // Calculate last value.
    // This happens 255*(2\hat{ }c* colMax)\hat{ }(1/gamma) is exactly 254.5,
    // which is equivalent to cMin = gamma*log(254.5/255)/log(2) − log(colMax)/log(2).
    double cMax = 2.2 * log(254.5/255.0)/I2 − log(colMax)/I2;
    // If cMin is, say, −10.6, the first valid integer c will be −10.
    int cMinInt = double2IntCeil(cMin);
    // If cMax is, say, 4.6, the last valid integer c will be 4.
    int cMaxInt = double2IntFloor(cMax);
    // Use the fact that nextValue = oldValue*(2\hat{ }(1/gamma)).
    double twoToC = exp((cMinInt−1)*I2);
    double factor = exp(inverseGamma*I2);
    // Starting values.
    double rOrigProcessed = 255.0 * exp( inverseGamma * log( ((1.0 * (twoToC))*rOrig) ) );
    double gOrigProcessed = 255.0 * exp( inverseGamma * log( ((1.0 * (twoToC))*gOrig) ) );
    double bOrigProcessed = 255.0 * exp( inverseGamma * log( ((1.0 * (twoToC))*bOrig) ) );
    double rCopyProcessed = 255.0 * exp( inverseGamma * log( ((1.0 * (twoToC))*rCopy) ) );
    double gCopyProcessed = 255.0 * exp( inverseGamma * log( ((1.0 * (twoToC))*gCopy) ) );
    double bCopyProcessed = 255.0 * exp( inverseGamma * log( ((1.0 * (twoToC))*bCopy) ) );
    for(int c = cMinInt; c<=cMaxInt; c++) {
      rOrigProcessed *= factor;
      gOrigProcessed *= factor;
      bOrigProcessed *= factor;
      rCopyProcessed *= factor;
      gCopyProcessed *= factor;
      bCopyProcessed *= factor;
      // Now clamp these values to [0, 255] and round to integer.
      // After clamping, all values are positive and we can use (int)(x+.5) instead of dRound(x).
      // Even before clamping, all values are postivie since 255*(2\hat{ }c* x)\hat{ }(1/gamma) > 0 if x > 0,
      // hence we can use dMin(x, 255) instead of dClip(x, 0, 255).
      // Original values are guaranteed to be below 254.5 so can avoid clamping altogether.
      int LDRorigR = (int) (rOrigProcessed+0.5);
      int LDRorigG = (int) (gOrigProcessed+0.5);
      int LDRorigB = (int) (bOrigProcessed+0.5);
      int LDRcopyR = (int) dMin( rCopyProcessed+0.5, 255.5);
      int LDRcopyG = (int) dMin( gCopyProcessed+0.5, 255.5);
      int LDRcopyB = (int) dMin( bCopyProcessed+0.5, 255.5);
      m_sse[R_COMP] += (LDRorigR − LDRcopyR)*(LDRorigR − LDRcopyR);
      m_sse[G_COMP] += (LDRorigG − LDRcopyG)*(LDRorigG − LDRcopyG);
      m_sse[B_COMP] += (LDRorigB − LDRcopyB)*(LDRorigB − LDRcopyB);
    }
    numPixels += (cMaxInt − cMinInt + 1);
  }
  sse = m_sse[R_COMP] + m_sse[G_COMP] + m_sse[B_COMP];
  mse = sse/(3.0*numPixels);
  mPSRN = 10*log((255*255)/mse/log(10);
  return mPSRN;
}
```

In this code, the linear light RGB-values of the original HDR video frame are found in inp0Comp0[x], inp0Comp1[x] and inp0Comp2[x], respectively. The corresponding values for the compressed HDR video frame, i.e. the reconstructed HDR video frame, are found in inp1Comp0[x], inp2Comp1[x] and inp1Comp2[x], respectively.

The clamped values are found in rOrig, gOrig, bOrig, respectively, for the original HDR video frame and rCopy, gCopy, BoCopy, respectively, for the compressed HDR video frame, i.e. the reconstructed HDR video frame.

The exposure values are found in rOrigProcessed, gOrigProcessed and bOrigProcesed, respectively, for the original HDR video frame and in rCopyProcessed, gCopyProcessed and bCopyProcessed, respectively, for the compressed HDR video frame, i.e. the reconstructed HDR video frame.

The LDR values are found in LDRorigR, LDRorigG and LDRorigB for the original HDR video frame and LDRcopyR, LDRcopyG, LDRcopyB for the compressed HDR video frame, i.e. the reconstructed HDR video frame.

The final mPSNR value is found in the mPSNR variable.

The proposed embodiments obtain significant speed-up by reducing the number of exponential and logarithmic function calls that are typically used. It also takes advantage of the fact that some values are guaranteed to be within specific ranges so that clamping, i.e. clipping, and rounding operations can often be avoided or greatly simplified.

According to one aspect, an exposure value R_{P}^{C}(x,y) is calculated from a previous exposure value using a single multiplication. The exposure value is used to calculate the mPSNR value. In a preferred embodiment, the exposure value R_{P}^{C}(x,y) is calculated from the immediately preceding exposure value R_{P}^{C-1}(x,y) using a multiplication with a constant α=2^{(1/γ)} as R_{P}^{C}(x,y)=αR_{P}^{C-1}(x,y).

This is in contrast to the art which uses costly power function implemented by exp(.) and log(.) to calculate each exposure value.

Hence, a method of calculating the multi-exposure Peak Signal to Noise Ratio (mPSNR) measure is presented where an exposure value is calculated using only a single multiplication between a constant and a previously calculated exposure value.

In the exemplified embodiments, the red component R is used to exemplify a color space but a person skilled in the art would realize that the embodiments are also valid for green G and blue B as well as for other color spaces, such as YCbCr, YUV, Lab, XYZ, etc.

According to an another aspect, an exposure value R_{P}^{C}(x,y) is converted to an LDR value R_{LDR}^{C}(x,y) by using an addition of 0.5 and a casting operation. This is in contrast to rounding and clamping operations involving conditional statements, if-statements, which typically take much longer to execute. This may be valid for an original video frame.

According to yet another aspect, an exposure value R_{P}^{C}(x,y) is converted to an LDR value R_{LDR}^{C}(x,y) by using an addition of 0.5, a min-function and a casting operation. This is in contrast to rounding and clamping operations involving conditional statements, if-statements, which typically take much longer to execute than a min-operation including only a single conditional statement, if-statement. This may be valid for a compressed video frame.

FIG. 6 is a flow chart illustrating a method of encoding a HDR video frame. The method comprises compressing at least a portion of the HDR video frame according to multiple compression modes in step S20 to obtain multiple compressed versions of the at least a portion of the HDR video frame. The following step S21 comprises determining, for each compression mode of the multiple compression modes, a respective evaluation measure for the HDR video frame according to the embodiments. A next step S22 comprises selecting a compressed version of the at least a portion of the HDR video frame as an encoded presentation of the at least a portion of the HDR video frame based on the multiple evaluation measures.

In the method as shown in FIG. 6 a complete HDR video frame is compressed or encoded or a portion of the HDR video frame is compressed or encoded. This portion could, for instance, correspond to a slice of the HDR video frame or indeed a block of pixels in the HDR video frame. Generally, a HDR video frame or a portion thereof can be compressed or encoded according to multiple compression or encoding modes. For instance, in video coding according to H.264 and H.265 (HEVC) a video frame, also referred to as image or picture, could be encoded as an intra frame according to one of multiple intra prediction modes or as an inter frame according to various inter prediction modes. In such a case, steps S20 and S21 are performed for each such compression or encoding mode, which is schematically represented by the line L3 in FIG. 6.

This means that an original HDR video frame 10 or a portion thereof is compressed or encoded according to a first compression or encoding mode in step S20 to get a compressed HDR video frame. This compressed HDR video frame is then decompressed or decoded according to corresponding decompression or decoding mode to get a reconstructed HDR video frame 20. An evaluation measure is then calculated for the given original HDR video frame—reconstructed HDR video frame pair, i.e. for the current compression or encoding mode.

This procedure is then performed for the other available compression or encoding modes giving a respective reconstructed HDR video frame 20. Please note that in the different compression or encoding modes the original HDR video frame 10 is the same. Accordingly, there is generally no need to recalculate exposure values of the pixels in the original HDR video frame 10 for the other compression or encoding modes to be tested. Hence, only the exposure values of the reconstructed HDR video frame 20 need to be calculated for the second and following compression or encoding modes. The compression in step S20 and the determination in step S21 can be performed at least partly in parallel for the different compression modes in order to speed up the calculations.

Each tested compression or encoding mode will thereby result in a respective evaluation measure as determined in step S21 and as described herein. The different evaluation measures are then compared in step S22 in order to select one the compressed versions of the HDR video frame 10 or the portion thereof as encoded representation of the original HDR vide frame 10.

In a particular embodiment, step S22 comprises selecting, as the encoded representation of the at least a portion of the HDR video frame 10, a compressed version of the at least a portion of the HDR video frame 10 having a highest evaluation measure among the multiple compressed versions of the at least a portion of the HDR video frame 10.

Thus, the compressed version of the at least a portion of the HDR video frame 10 obtained using the compression or encoding mode resulting in the highest or largest evaluation measure is thereby selected and used as encoded representation of the at least a portion of the HDR video frame 10.

Another aspect of the embodiments relates to an encoder for determining an evaluation measure for a HDR video frame. The encoder is configured to calculate, for each pixel in the HDR video frame, an initial exposure value of the pixel in the HDR video frame using a smallest exposure parameter value. The encoder is also configured to calculate, for each pixel in the HDR video frame, an initial exposure value of a corresponding pixel in a version of the HDR video frame obtained following compression of the HDR video frame. The encoder is further configured to calculate, for each pixel in the HDR video frame and for each exposure parameter value starting from the smallest exposure parameter value up to a largest exposure parameter value, an exposure value of the pixel in the HDR video frame from a previously calculated exposure value of the pixel in the HDR video frame multiplied by a constant. The encoder is additionally configured to calculate, for each pixel in the HDR video frame and for each exposure parameter value, an exposure value of the corresponding pixel in the version of the HDR video frame obtained following compression of the HDR video frame from a previously calculated exposure value of the corresponding pixel in the version of the HDR video frame obtained following compression of the HDR video frame multiplied by the constant. The encoder is also configured to convert, for each pixel in the HDR video frame and for each exposure parameter value, the exposure value of the pixel in the HDR video frame into a LDR value for the pixel in the HDR video frame. The encoder is further configured to convert, for each pixel in the HDR video frame and for each exposure parameter value, the exposure value of the corresponding pixel in the version of the HDR video frame obtained following compression of the HDR video frame into a LDR value for the corresponding pixel in the version of the HDR video frame obtained following compression of the HDR video frame. The encoder is additionally configured to calculate, for each pixel in the HDR video frame and for each exposure parameter value, an error representing a difference between the LDR value for the pixel in the HDR video frame and the LDR value for the corresponding pixel in the version of the HDR video frame obtained following compression of the HDR video frame. The encoder is also configured to calculate the evaluation measure based on the errors for all pixels in the HDR video frame and for all exposure parameter values.

In an embodiment, the encoder is configured to convert, for each pixel in the HDR video frame and for each exposure parameter value, the exposure value of the pixel in the HDR video frame into the LDR value using an addition of 0.5 and a casting operation.

In an embodiment, the encoder is configured to convert, for each pixel in the HDR video frame and for each exposure parameter value, the exposure value of the corresponding pixel in the version of the HDR video frame obtained following compression of the HDR video frame into the LDR value using an addition of 0.5, a min function and a casting operation.

In an embodiment, each pixel in the HDR video frame comprises a red color component, a blue color component and a green color component. The encoder is, in this embodiment, configured to calculate, for each pixel in the HDR video frame, the smallest exposure parameter value based on ceil(γ×log(0.5/255.0)/log(2)−log(colMax)/log(2)). The encoder is also configured to calculate, for each pixel in the HDR video frame, the largest exposure value based on floor(γ×log(254.5/255.0)/log(2)−log(colMax)/log(2)).

In an embodiment, the encoder is configured to calculate, for each pixel in the HDR video frame:

rOrigProcessed=255.0×exp((1.0/γ)×log(1.0×twoToC×rOrig))

gOrigProcessed=255.0×exp((1.0/γ)×log(1.0×twoToC×gOrig))

bOrigProcessed=255.0×exp((1.0/γ)×log(1.0×twoToC×bOrig))

rCopyProcessed=255.0×exp((1.0/γ)×log(1.0×twoToC×rCopy))

gCopyProcessed=255.0×exp((1.0/γ)×log(1.0×twoToC×gCopy))

bCopyProcessed=255.0×exp((1.0/γ)×log(1.0×twoToC×bCopy)).

In an embodiment, the encoder is configured to calculate, for each pixel in the HDR video frame and for each exposure parameter value:

rOrigProcessed×=factor

gOrigProcessed×=factor

bOrigProcessed×=factor

rCopyProcessed×=factor

gCopyProcessed×=factor

bCopyProcessed×=factor.

In an embodiment, the encoder is configured to calculate, for each pixel in the HDR video frame and for each exposure parameter value:

LDRorigR=(int)(rOrigProcessed+0.5)

LDRorigG=(int)(gOrigProcessed+0.5)

LDRorigB=(int)(bOrigProcessed+0.5)

LDRcopyR=(int)dMin(rCopyProcessed+0.5,255.5)

LDRcopyG=(int)dMin(gCopyProcessed+0.5,255.5)

LDRcopyB=(int)dMin(bCopyProcessed+0.5,255.5).

In an embodiment, the encoder is configured to calculate the error as (LDRorigR−LDRcopyR)×(LDRorigR−LDRcopyR)+(LDRorigG−LDRcopyG)×(LDRorigG−LDRcopyG)+(LDRorigB−LDRcopyB)×(LDRorigB−LDRcopyB).

In another embodiment, the encoder is configured to calculate the error as w_{R}×(LDRorigR−LDRcopyR)×(LDRorigR−LDRcopyR)+w_{G}×(LDRorigG−LDRcopyG)×(LDRorigG−LDRcopyG)+w_{B}×(LDRorigB−LDRcopyB)×(LDRorigB−LDRcopyb), wherein w_{R}, w_{G}, w_{B} are weights.

In a further embodiment, the encoder is configured to calculate the error as |LDRorigR−LDRcopyR|+|LDRorigG−LDRcopyG|+|LDRorigB−LDRcopyB|.

In yet another embodiment, the encoder is configured to calculate the error as w_{R}×|LDRorigR−LDRcopyR|+w_{G}×|LDRorigG−LDRcopyG|+w_{B}×|LDRorigB−LDRcopyB|.

In an embodiment, the encoder is configured to calculate a mean squared error as an average error for all pixels in the HDR video frame and for all exposure parameter values. The encoder is, in this embodiment, also configured to calculate the evaluation measure based on the mean squared error.

In an embodiment, the encoder is configured to calculate the evaluation measure as a peak signal-to-noise ratio of the mean squared error as 10×log((255×255)/MSE)/log(10).

It will be appreciated that the methods and arrangements described herein can be implemented, combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

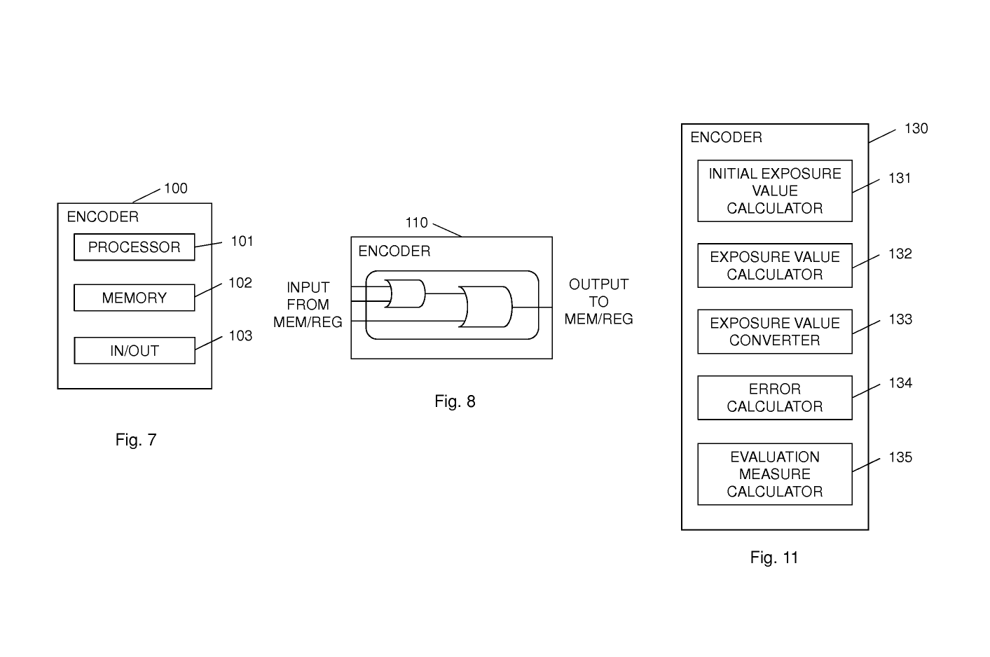

FIG. 7 is a schematic block diagram illustrating an example of an encoder 100, based on a processor-memory implementation according to an embodiment. In this particular example, the encoder 100 comprises a processor 101 and a memory 102. The memory 102 comprises instructions executable by the processor 110. The processor 101 is operative to calculate the initial exposure values, calculate the exposure values, convert the exposure values into the LDR values, calculate the error, and calculate the evaluation measure.

Optionally, the encoder 100 may also include an input and output unit 103 as an illustrative example of a communication circuit. The input and output unit 103 may include functions for wired and/or wireless communication with other devices and/or network nodes. In a particular example, the input and output unit 103 may be based on radio circuitry for communication with one or more other nodes, including transmitting and/or receiving information. The input and output unit 103 may be interconnected to the processor 101 and/or memory 102. By way of example, the input and output unit 103 may include any of the following: a receiver, a transmitter, a transceiver, input/output (I/O) circuitry, input port(s) and/or output port(s).

In a particular embodiment, the input and output unit 103 is configured to receive HDR video frames to be encoded or compressed and outputs a bitstream comprising encoded or compressed HDR video frames.

FIG. 8 is a schematic block diagram illustrating another example of an encoder 110, based on a hardware circuitry implementation according to an embodiment. Particular examples of suitable hardware circuitry include one or more suitably configured or possibly reconfigurable electronic circuitry, e.g. Application Specific Integrated Circuits (ASICs), Field Programmable Gate Arrays (FPGAs), or any other hardware logic such as circuits based on discrete logic gates and/or flip-flops interconnected to perform specialized functions in connection with suitable registers (REG), and/or memory units (MEM).

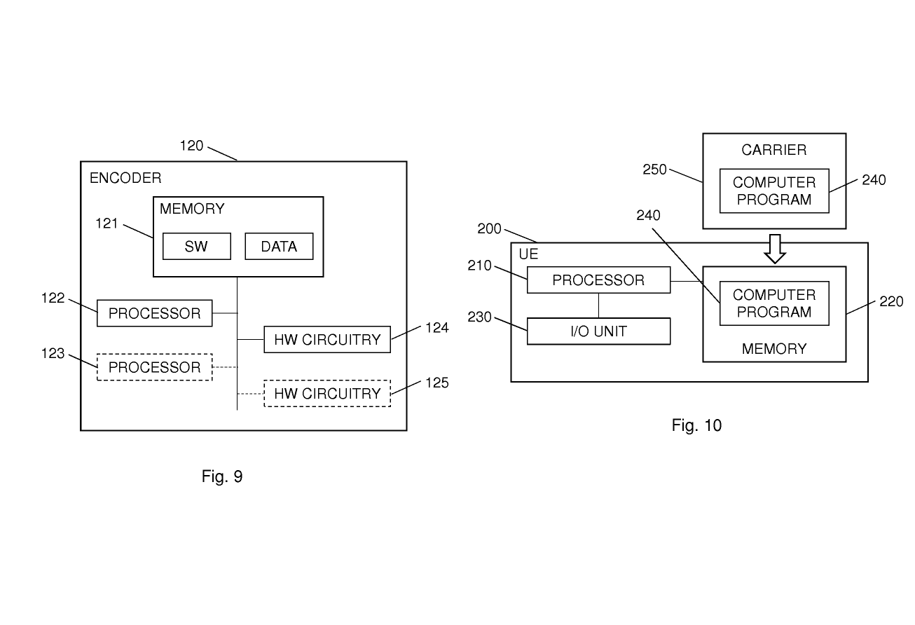

FIG. 9 is a schematic block diagram illustrating yet another example of an encoder 120, based on combination of both processor(s) 122, 123 and hardware circuitry 124, 125 in connection with suitable memory unit(s) 121. The encoder 120 comprises one or more processors 122, 123, memory 121 including storage for software (SW) and data, and one or more units of hardware circuitry 124, 125, such as ASICs and/or FPGAs. The overall functionality is, thus, partitioned between programmed software for execution on one or more processors 122, 123, and one or more pre-configured or possibly reconfigurable hardware circuits 124, 125, such as ASICs and/or FPGAs. The actual hardware-software partitioning can be decided by a system designer based on a number of factors including processing speed, cost of implementation and other requirements.

FIG. 10 is a schematic diagram illustrating an example of a computer-implementation of a user equipment (UE) 200 according to an embodiment. In this particular example, at least some of the steps, functions, procedures, modules and/or blocks described herein are implemented in a computer program 240, which is loaded into the memory 240 for execution by processing circuitry including one or more processors 210. The processor(s) 210 and memory 220 are interconnected to each other to enable normal software execution. An optional input/output (I/O) unit 230 may also be interconnected to the processor(s) 210 and/or the memory 220 to enable input of HDR video frames to be encoded or compressed and/or output of a bitstream of encoded or compressed HDR video frames.

The term ‘processor’ should be interpreted in a general sense as any system or device capable of executing program code or computer program instructions to perform a particular processing, determining or computing task.

The processing circuitry including one or more processors 210 is thus configured to perform, when executing the computer program 240, well-defined processing tasks such as those described herein.

The processing circuitry does not have to be dedicated to only execute the above-described steps, functions, procedure and/or blocks, but may also execute other tasks.

In a particular embodiment, the computer program 240 comprises instructions, which when executed by a processor 210, cause the processor 210 to calculate, for each pixel in the HDR video frame, an initial exposure value of the pixel in the HDR video frame using a smallest exposure parameter value. The processor 210 is also caused to calculate, for each pixel in the HDR video frame, an initial exposure value of a corresponding pixel in a version of the HDR video frame obtained following compression of the HDR video frame. The processor 210 is further caused to calculate, for each pixel in the HDR video frame and for each exposure parameter value starting from the smallest exposure parameter value up to a largest exposure parameter value, an exposure value of the pixel in the HDR video frame from a previously calculated exposure value of the pixel in the HDR video frame multiplied by a constant. The processor 210 is additionally caused to calculate, for each pixel in the HDR video frame and for each exposure parameter value, an exposure value of the corresponding pixel in the version of the HDR video frame obtained following compression of the HDR video frame from a previously calculated exposure value of the corresponding pixel in the version of the HDR video frame obtained following compression of the HDR video frame multiplied by the constant. The processor 210 is also caused to convert, for each pixel in the HDR video frame and for each exposure parameter value, the exposure value of the pixel in the HDR video frame into a LDR value for the pixel in the HDR video frame. The processor 210 is further caused to convert, for each pixel in the HDR video frame and for each exposure parameter value, the exposure value of the corresponding pixel in the version of the HDR video frame obtained following compression of the HDR video frame into a LDR value for the corresponding pixel in the version of the HDR video frame obtained following compression of the HDR video frame. The processor 210 is additionally caused to calculate, for each pixel in the HDR video frame and for each exposure parameter value, an error representing a difference between the LDR value for the pixel in the HDR video frame and the LDR value for the corresponding pixel in the version of the HDR video frame obtained following compression of the HDR video frame. The processor 210 is also caused to calculate the evaluation measure based on the errors for all pixels in the HDR video frame and for all exposure parameter values.

The proposed technology also provides a carrier 250 comprising the computer program 240. The carrier 250 is one of an electronic signal, an optical signal, an electromagnetic signal, a magnetic signal, an electric signal, a radio signal, a microwave signal, or a computer-readable storage medium.

By way of example, the software or computer program 240 may be realized as a computer program product, which is normally carried or stored on a computer-readable medium 250, in particular a non-volatile medium. The computer-readable medium 250 may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program 240 may thus be loaded into the operating memory of a computer or equivalent processing device, represented by the user equipment 200 in FIG. 10, for execution by the processing circuitry thereof.

The flow diagram or diagrams presented herein may be regarded as a computer flow diagram or diagrams, when performed by one or more processors. A corresponding encoder may be defined as a group of function modules, where each step performed by the processor corresponds to a function module. In this case, the function modules are implemented as a computer program running on the processor.

The computer program residing in memory may thus be organized as appropriate function modules configured to perform, when executed by the processor, at least part of the steps and/or tasks described herein.

FIG. 11 is a schematic diagram illustrating an example of an encoder 130 for determining an evaluation measure for a HDR video frame. The encoder 130 comprises an initial exposure value calculator 131 for calculating, for each pixel in the HDR video frame, i) an initial exposure value of the pixel in the HDR video frame using a smallest exposure parameter value and ii) an initial exposure value of a corresponding pixel in a version of the HDR video frame obtained following compression of the HDR video frame. The encoder 130 also comprises an exposure value calculator 132 for calculating, for each pixel in the HDR video frame and for each exposure parameter value starting from the smallest exposure parameter value up to a largest exposure parameter value, i) an exposure value of the pixel in the HDR video frame from a previously calculated exposure value of the pixel in the HDR video frame multiplied by a constant and ii) an exposure value of the corresponding pixel in the version of the HDR video frame obtained following compression of the HDR video frame from a previously calculated exposure value of the corresponding pixel in the version of the HDR video frame obtained following compression of the HDR video frame multiplied by the constant. The encoder 130 further comprises an exposure value converter 133 for converting, for each pixel in the HDR video frame and for each exposure parameter value, i) the exposure value of the pixel in the HDR video frame into a LDR value for the pixel in the HDR video frame and ii) the exposure value of the corresponding pixel in the version of the HDR video frame obtained following compression of the HDR video frame into a LDR value for the corresponding pixel in the version of the HDR video frame obtained following compression of the HDR video frame. The encoder 130 additionally comprises an error calculator 134 for calculating, for each pixel in the HDR video frame and for each exposure parameter value, an error representing a difference between the LDR value for the pixel in the HDR video frame and the LDR value for the corresponding pixel in the version of the HDR video frame obtained following compression of the HDR video frame. The encoder 130 further comprises an evaluation measure calculator 135 for calculating the evaluation measure based on the errors for all pixels in the HDR video frame and for all exposure parameter values.

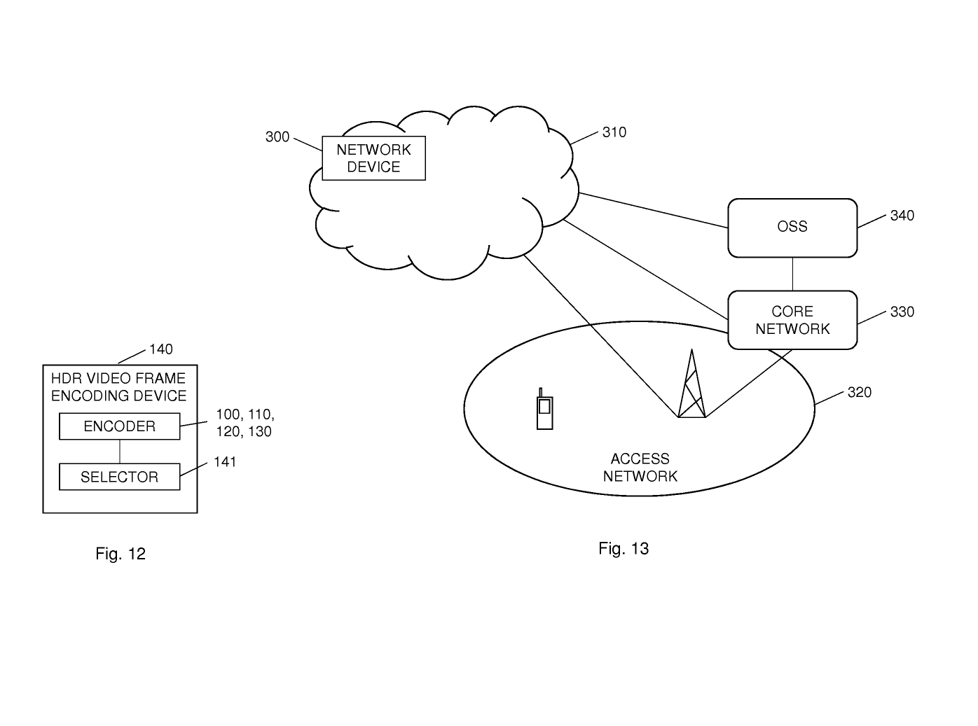

A further aspect of the embodiments relates to a HDR video frame encoding device 140 as shown in FIG. 12. The HDR video frame encoding device 140 comprises an encoder 100, 110, 120, 130 of the embodiments as described above and disclosed in any of FIGS. 7-9, 11. The encoder 100, 110, 120, 130 is configured to compress at least a portion of a HDR video frame according to multiple compression modes to obtain multiple compressed versions of the at least a portion of the HDR video frame and determine, for each compression mode of the multiple compression modes, a respective evaluation measure for the HDR video frame. The HDR video frame encoding device 140 also comprises a selector 141 configured to select a compressed version of the at least a portion of the HDR video frame as an encoded representation of the at least a portion of HDR video frame based on multiple evaluation measures.

In an embodiment, the selector 141 is configured to select, as the encoded representation of the at least a portion of the HDR video frame, a compressed version of the HDR video frame having a highest evaluation measure among the multiple compressed versions of the at least a portion of HDR video frame.

The selector 141 could be implemented by a processor together with the other functions of the encoder 100 as shown in FIG. 7, a hardware element as shown in FIG. 8, a combination of software+processor and hardware elements as shown in FIG. 9 or as a functional module as shown in FIG. 11.

The HDR video frame encoding device 140 may furthermore be implemented as a computer program comprising instructions executable by a processor.

It is becoming increasingly popular to provide computing services in network devices, such as network nodes and/or servers, where the resources are delivered as a service to remote locations over a network. By way of example, this means that functionality, as described herein, can be distributed or re-located to one or more separate physical nodes or servers. The functionality may be re-located or distributed to one or more jointly acting physical and/or virtual machines that can be positioned in separate physical node(s), i.e. in the so-called cloud. This is sometimes also referred to as cloud computing, which is a model for enabling ubiquitous on-demand network access to a pool of configurable computing resources such as networks, servers, storage, applications and general or customized services.

FIG. 13 is a schematic diagram illustrating an example of a wireless communication system, including an access network 320 and/or a core network 330 and/or an Operations and Support System (OSS) 340 in cooperation with one or more cloud-based network devices 300. In such a case, the determination of an evaluation measure for a HDR video frame and/or encoding a HDR video frame as disclosed herein may be implemented in one or more such network devices 300 interconnected through a network 310.

A network device 300 may generally be seen as an electronic device being communicatively connected to other electronic devices in the network 310.

By way of example, the network device 300 may be implemented in hardware, software or a combination thereof. For example, the network device 300 may be a special-purpose network device or a general purpose network device, or a hybrid thereof.

The method according to the different aspects can be implemented by a device, e.g. an encoder. Further, the device may be a user device, such as a video camera, cellular phone, smart phone, etc.

Such a device is, hence, configured to perform the method steps described in accordance with the different embodiments and aspects.

The device may comprise a memory for storing instructions, e.g. as software code for performing the method and a processor configured to execute the instructions.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

### REFERENCES

[1] Munkberg et al., “High dynamic range texture compression for graphics hardware”, ACM Transactions on Graphics (Proceedings of AM SIGGRAPH 2006, vol. 25, no. 3, 2006

1-28. (canceled)

29. A method for determining an evaluation measure for a high dynamic range, HDR, video frame comprising:
performing for each pixel in said HDR video frame:
calculating an initial exposure value of said pixel in said HDR video frame using a smallest exposure parameter value;
calculating an initial exposure value of a corresponding pixel in a version of said HDR video frame obtained following compression of said HDR video frame; and
performing, for each exposure parameter value starting from said smallest exposure parameter value up to a largest exposure parameter value, the steps of:
calculating, for said exposure parameter value, an exposure value of said pixel in said HDR video frame from a previously calculated exposure value of said pixel in said HDR video frame multiplied by a constant;
calculating, for said exposure parameter value, an exposure value of said corresponding pixel in said version of said HDR video frame obtained following compression of said HDR video frame from a previously calculated exposure value of said corresponding pixel in said version of said HDR video frame obtained following compression of said HDR video frame multiplied by said constant;
converting said exposure value of said pixel in said HDR video frame into a low dynamic range, LDR, value for said pixel in said HDR video frame;
converting said exposure value of said corresponding pixel in said version of said HDR video frame obtained following compression of said HDR video frame into a LDR value for said corresponding pixel in said version of said HDR video frame obtained following compression of said HDR video frame; and
calculating an error representing a difference between said LDR value for said pixel in said HDR video frame and said LDR value for said corresponding pixel in said version of said HDR video frame obtained following compression of said HDR video frame; and
calculating said evaluation measure based on said errors for all pixels in said HDR video frame and for all exposure parameter values.

30. The method according to claim 29, wherein converting said exposure value of said pixel in said HDR video frame comprises converting said exposure value of said pixel in said HDR video frame into said LDR value using an addition of 0.5 and a casting operation.

31. The method according to claim 29, wherein converting said exposure value of said corresponding pixel in said version of said HDR video frame obtained following compression of said HDR video frame comprises converting said exposure value of said corresponding pixel in said version of said HDR video frame obtained following compression of said HDR video frame into said LDR value using an addition of 0.5, a min function and a casting operation.

32. The method according to claim 29, wherein each pixel in said HDR video frame comprises a red color component, a blue color component and a green color component, said method further comprising:
calculating said smallest exposure parameter value based on ceil(γ×log(0.5/255.0)/log(2)−log(colMax)/log(2)), wherein ceil(x) rounds x up, γ represents a display gamma, colMax represents a largest color component value of said red color component, said green color component and said blue color component of said pixel in said HDR video frame;
calculating said largest parameter exposure value based on floor(γ×log(254.5/255.0)/log(2)−log(colMax)/log(2)), wherein floor(x) rounds x down.

33. The method according to claim 32, wherein
calculating said initial exposure value of said pixel in said HDR video frame comprises calculating:
rOrigProcessed=255.0×exp((1.0/γ)×log(1.0×twoToC×rOrig))
gOrigProcessed=255.0×exp((1.0/γ)×log(1.0×twoToC×gOrig))
bOrigProcessed=255.0×exp((1.0/γ)×log(1.0×twoToC×bOrig),)
wherein rOrigProcessed represents an exposure value of a red color component of said pixel in said HDR video frame, gOrigProcessed represents an exposure value of a green color component of said pixel in said HDR video frame, bOrigProcessed represents an exposure value of a blue color component of said pixel in said HDR video frame, twoToC=exp((cMin−1)×log(2.0)), cMin represents said smallest exposure parameter value, rOrig represents said red color component of said pixel in said HDR video frame, gOrig represents said green color component of said pixel in said HDR video frame, bOrig represents said blue color component of said pixel in said HDR video frame; and
calculating said initial exposure value of said corresponding pixel in said version of said HDR video frame obtained following compression of said HDR video frame comprises calculating:
rCopyProcessed=255.0×exp((1.0/γ)×log(1.0×twoToC×rCopy))
gCopyProcessed=255.0×exp((1.0/γ)×log(1.0×twoToC×gCopy))
bCopyProcessed=255.0×exp((1.0/γ)×log(1.0×twoToC×bCopy)),
wherein rCopyProcessed represents an exposure value of a red color component of said corresponding pixel in said version of said HDR video frame obtained following compression of said HDR video frame, gCopyProcessed represents an exposure value of a green color component of said corresponding pixel in said version of said HDR video frame obtained following compression of said HDR video frame, bCopyProcessed represents an exposure value of a blue color component of said corresponding pixel in said version of said HDR video frame obtained following compression of said HDR video frame, rCopy represents said red color component of said corresponding pixel in said version of said HDR video frame obtained following compression of said HDR video frame, gCopy represents said green color component of said corresponding pixel in said version of said HDR video frame obtained following compression of said HDR video frame, bCopy represents said blue color component of said corresponding pixel in said version of said HDR video frame obtained following compression of said HDR video frame.

34. The method according to claim 33, wherein
calculating said exposure value of said pixel in said HDR video frame comprises calculating, for each exposure parameter value starting from said smallest exposure parameter value up to said largest exposure parameter value:
rOrigProcessed×=factor
gOrigProcessed×=factor
bOrigProcessed×=factor,
wherein factor=exp((1.0/γ)×log(2.0)); and
calculating said exposure value of said corresponding pixel in said version of said HDR video frame obtained following compression of said HDR video frame comprises calculating, for each exposure parameter value starting from said smallest exposure parameter value up to said largest exposure parameter value:
rCopyProcessed×=factor
gCopyProcessed×=factor
bCopyProcessed×=factor.

35. The method according to claim 34, wherein
converting said exposure value of said pixel in said HDR video frame comprises calculating:
LDRorigR=(int)(rOrigProcessed+0.5)
LDRorigG=(int)(gOrigProcessed+0.5)
LDRorigB=(int)(bOrigProcessed+0.5),
wherein LDRorigR represents a LDR value of a red color component of said pixel in said HDR video frame, LDRorigG represents a LDR value of a green color component of said pixel in said HDR video frame, LDRorigB represents a LDR value of a blue color component of said pixel in said HDR video frame, (int) represents a casting operation; and
converting said exposure value of said corresponding pixel in said version of said HDR video frame obtained following compression of said HDR video frame comprises calculating:
LDRcopyR=(int)dMin(rCopyProcessed+0.5,255.5)
LDRcopyG=(int)dMin(gCopyProcessed+0.5,255.5)
LDRcopyB=(int)dMin(bCopyProcessed+0.5,255.5),
wherein LDRcopyR represent a LDR value of a red color component of said corresponding pixel in said version of said HDR video frame obtained following compression of said HDR video frame, LDRcopyG represent a LDR value of a green color component of said corresponding pixel in said version of said HDR video frame obtained following compression of said HDR video frame, LDRcopyB represent a LDR value of a blue color component of said corresponding pixel in said version of said HDR video frame obtained following compression of said HDR video frame, dMin(x, y) represents a min function implemented as: if (x>y) return y, else return x.

36. The method according to claim 35, wherein calculating said error comprises calculating said error as:
(LDRorigR−LDRcopyR)×(LDRorigR−LDRcopyR)+(LDRorigG−LDRcopyG)×(LDRorigG−LDRcopyG)+(LDRorigB−LDRcopyB)×(LDRorigB−LDRcopyB).

37. The method according to claim 35, wherein calculating said error comprises calculating said error as:
w_{R}×(LDRorigR−LDRcopyR)×(LDRorigR−LDRcopyR)+w_{G}×(LDRorigG−LDRcopyG)×(LDRorigG−LDRcopyG)+w_{B}×(LDRorigB−LDRcopyB)×(LDRorigB−LDRcopyb),
wherein w_{R}, w_{G}, w_{B} are weights.

38. The method according to claim 29, wherein calculating said evaluation measure comprises:
calculating a mean squared error as an average error for all pixels in said HDR video frame and for all exposure parameter values; and
calculating said evaluation measure based on said mean squared error.

39. The method according to claim 38, wherein calculating said evaluation measure comprises calculating said evaluation measure as a peak signal-to-noise ratio of said mean squared error as:
10×log((255×255)/MSE)/log(10)
wherein MSE represents said mean squared error.

40. A method of encoding a high dynamic range, HDR, video frame, said method comprising:
compressing at least a portion of said HDR video frame according to multiple compression modes to obtain multiple compressed versions of said at least a portion of said HDR video frame;
determining, for each compression mode of said multiple compression modes, a respective evaluation measure for said HDR video frame according to claim 29; and
selecting a compressed version of said at least a portion of said HDR video frame as an encoded representation of said at least a portion of said HDR video frame based on said multiple evaluation measures.

41. An encoder for determining an evaluation measure for a high dynamic range, HDR, video frame, wherein
said encoder is configured to calculate, for each pixel in said HDR video frame, an initial exposure value of said pixel in said HDR video frame using a smallest exposure parameter value;
said encoder is configured to calculate, for each pixel in said HDR video frame, an initial exposure value of a corresponding pixel in a version of said HDR video frame obtained following compression of said HDR video frame;
said encoder is configured to calculate, for each pixel in said HDR video frame and for each exposure parameter value starting from said smallest exposure parameter value up to a largest exposure parameter value, an exposure value of said pixel in said HDR video frame from a previously calculated exposure value of said pixel in said HDR video frame multiplied by a constant;
said encoder is configured to calculate, for each pixel in said HDR video frame and for each exposure parameter value starting from said smallest exposure parameter value up to said largest exposure parameter value, an exposure value of said corresponding pixel in said version of said HDR video frame obtained following compression of said HDR video frame from a previously calculated exposure value of said corresponding pixel in said version of said HDR video frame obtained following compression of said HDR video frame multiplied by said constant;
said encoder is configured to convert, for each pixel in said HDR video frame and for each exposure parameter value starting from said smallest exposure parameter value up to said largest exposure parameter value, said exposure value of said pixel in said HDR video frame into a low dynamic range, LDR, value for said pixel in said HDR video frame;
said encoder is configured to convert, for each pixel in said HDR video frame and for each exposure parameter value starting from said smallest exposure parameter value up to said largest exposure parameter value, said exposure value of said corresponding pixel in said version of said HDR video frame obtained following compression of said HDR video frame into a LDR value for said corresponding pixel in said version of said HDR video frame obtained following compression of said HDR video frame;
said encoder is configured to calculate, for each pixel in said HDR video frame and for each exposure parameter value starting from said smallest exposure parameter value up to said largest exposure parameter value, an error representing a difference between said LDR value for said pixel in said HDR video frame and said LDR value for said corresponding pixel in said version of said HDR video frame obtained following compression of said HDR video frame; and
said encoder is configured to calculate said evaluation measure based on said errors for all pixels in said HDR video frame and for all exposure parameter values.

42. The encoder according to claim 41, wherein said encoder is configured to convert, for each pixel in said HDR video frame and for each exposure parameter value starting from said smallest exposure parameter value up to said largest exposure parameter value, said exposure value of said pixel in said HDR video frame into said LDR value using an addition of 0.5 and a casting operation.

43. The encoder according to claim 41, wherein said encoder is configured to convert, for each pixel in said HDR video frame and for each exposure parameter value starting from said smallest exposure parameter value up to said largest exposure parameter value, said exposure value of said corresponding pixel in said version of said HDR video frame obtained following compression of said HDR video frame into said LDR value using an addition of 0.5, a min function and a casting operation.

44. The encoder according to claim 41, wherein each pixel in said HDR video frame comprises a red color component, a blue color component and a green color component, wherein
said encoder is configured to calculate, for each pixel in said HDR video frame, said smallest exposure parameter value based on ceil(γ×log(0.5/255.0)/log(2)−log(colMax)/log(2)), wherein ceil(x) rounds x up, γ represents a display gamma, colMax represents a largest color component value of said red color component, said green color component and said blue color component of said pixel in said HDR video frame;
said encoder is configured to calculate, for each pixel in said HDR video frame, said largest exposure value based on floor(γ×log(254.5/255.0)/log(2)−log(colMax)/log(2)), wherein floor(x) rounds x down.

45. The encoder according to claim 44, wherein said encoder is configured to calculate, for each pixel in said HDR video frame:
rOrigProcessed=255.0×exp((1.0/γ)×log(1.0×twoToC×rOrig))
gOrigProcessed=255.0×exp((1.0/γ)×log(1.0×twoToC×gOrig))
bOrigProcessed=255.0×exp((1.0/γ)×log(1.0×twoToC×bOrig))
rCopyProcessed=255.0×exp((1.0/γ)×log(1.0×twoToC×rCopy))
gCopyProcessed=255.0×exp((1.0/γ)×log(1.0×twoToC×gCopy))
bCopyProcessed=255.0×exp((1.0/γ)×log(1.0×twoToC×bCopy)),
wherein rOrigProcessed represents an exposure value of a red color component of said pixel in said HDR video frame, gOrigProcessed represents an exposure value of a green color component of said pixel in said HDR video frame, bOrigProcessed represents an exposure value of a blue color component of said pixel in said HDR video frame, twoToC=exp((cMin−1)×log(2.0)), cMin represents said smallest exposure parameter value, rOrig represents said red color component of said pixel in said HDR video frame, gOrig represents said green color component of said pixel in said HDR video frame, bOrig represents said blue color component of said pixel in said HDR video frame, rCopyProcessed represents an exposure value of a red color component of said corresponding pixel in said version of said HDR video frame obtained following compression of said HDR video frame, gCopyProcessed represents an exposure value of a green color component of said corresponding pixel in said version of said HDR video frame obtained following compression of said HDR video frame, bCopyProcessed represents an exposure value of a blue color component of said corresponding pixel in said version of said HDR video frame obtained following compression of said HDR video frame, rCopy represents said red color component of said corresponding pixel in said version of said HDR video frame obtained following compression of said HDR video frame, gCopy represents said green color component of said corresponding pixel in said version of said HDR video frame obtained following compression of said HDR video frame, bCopy represents said blue color component of said corresponding pixel in said version of said HDR video frame obtained following compression of said HDR video frame.

46. The encoder according to claim 45, wherein said encoder is configured to calculate, for each pixel in said HDR video frame and for each exposure parameter value starting from said smallest exposure parameter value up to said largest exposure parameter value:
rOrigProcessed×=factor
gOrigProcessed×=factor
bOrigProcessed×=factor
rCopyProcessed×=factor
gCopyProcessed×=factor
bCopyProcessed×=factor,
wherein factor=exp((1.0/γ)×log(2.0)).

47. The encoder according to claim 46, wherein said encoder is configured to calculate, for each pixel in said HDR video frame and for each exposure parameter value starting from said smallest exposure parameter value up to said largest exposure parameter value:
LDRorigR=(int)(rOrigProcessed+0.5)
LDRorigG=(int)(gOrigProcessed+0.5)
LDRorigB=(int)(bOrigProcessed+0.5)
LDRcopyR=(int)dMin(rCopyProcessed+0.5,255.5)
LDRcopyG=(int)dMin(gCopyProcessed+0.5,255.5)
LDRcopyB=(int)dMin(bCopyProcessed+0.5,255.5),
wherein LDRorigR represents a LDR value of a red color component of said pixel in said HDR video frame, LDRorigG represents a LDR value of a green color component of said pixel in said HDR video frame, LDRorigB represents a LDR value of a blue color component of said pixel in said HDR video frame, (int) represents a casting operation, LDRcopyR represent a LDR value of a red color component of said corresponding pixel in said version of said HDR video frame obtained following compression of said HDR video frame, LDRcopyG represent a LDR value of a green color component of said corresponding pixel in said version of said HDR video frame obtained following compression of said HDR video frame, LDRcopyB represent a LDR value of a blue color component of said corresponding pixel in said version of said HDR video frame obtained following compression of said HDR video frame, dMin(x, y) represents a min function implemented as if (x>y) return y, else return x.

48. The encoder according to claim 47, wherein said encoder is configured to calculate said error as:
(LDRorigR−LDRcopyR)×(LDRorigR−LDRcopyR)+(LDRorigG−LDRcopyG)×(LDRorigG−LDRcopyG)+(LDRorigB−LDRcopyB)×(LDRorigB−LDRcopyB).

49. The encoder according to claim 47, wherein said encoder is configured to calculate said error as:
w_{R}×(LDRorigR−LDRcopyR)×(LDRorigR−LDRcopyR)+w_{G}×(LDRorigG−LDRcopyG)×(LDRorigG−LDRcopyG)+w_{B}×(LDRorigB−LDRcopyB)×(LDRorigB−LDRcopyb),
wherein w_{R}, w_{G}, w_{B} are weights.

50. The encoder according to claim 41, wherein
said encoder is configured to calculate a mean squared error as an average error for all pixels in said HDR video frame and for all exposure parameter values; and
said encoder is configured to calculate said evaluation measure based on said mean squared error.

51. The encoder according to claim 50, wherein said encoder is configured to calculate said evaluation measure as a peak signal-to-noise ratio of said mean squared error as:
10×log((255×255)/MSE)/log(10)
wherein MSE represents said mean squared error.

52. The encoder according to claim 41, comprising:
a processor; and
a memory comprising instructions executable by said processor, wherein said processor is operative to:
calculate said initial exposure values;
calculate said exposure values;
convert said exposure values into said LDR values;
calculate said error; and
calculate said evaluation measure.

53. An encoder for determining an evaluation measure for a high dynamic range, HDR, video frame, said encoder comprising:
an initial exposure value calculator for calculating, for each pixel in said HDR video frame, i) an initial exposure value of said pixel in said HDR video frame using a smallest exposure parameter value and ii) an initial exposure value of a corresponding pixel in a version of said HDR video frame obtained following compression of said HDR video frame;
an exposure value calculator for calculating, for each pixel in said HDR video frame and for each exposure parameter value starting from said smallest exposure parameter value up to a largest exposure parameter value, i) an exposure value of said pixel in said HDR video frame from a previously calculated exposure value of said pixel in said HDR video frame multiplied by a constant and ii) an exposure value of said corresponding pixel in said version of said HDR video frame obtained following compression of said HDR video frame from a previously calculated exposure value of said corresponding pixel in said version of said HDR video frame obtained following compression of said HDR video frame multiplied by said constant;
an exposure value converter for converting, for each pixel in said HDR video frame and for each exposure parameter value starting from said smallest exposure parameter value up to said largest exposure parameter value, i) said exposure value of said pixel in said HDR video frame into a low dynamic range, LDR, value for said pixel in said HDR video frame and ii) said exposure value of said corresponding pixel in said version of said HDR video frame obtained following compression of said HDR video frame into a LDR value for said corresponding pixel in said version of said HDR video frame obtained following compression of said HDR video frame;
an error calculator for calculating, for each pixel in said HDR video frame and for each exposure parameter value starting from said smallest exposure parameter value up to said largest exposure parameter value, an error representing a difference between said LDR value for said pixel in said HDR video frame and said LDR value for said corresponding pixel in said version of said HDR video frame obtained following compression of said HDR video frame; and
an evaluation measure calculator for calculating said evaluation measure based on said errors for all pixels in said HDR video frame and for all exposure parameter values.

54. A high dynamic range, HDR, video frame encoding device comprising:
an encoder according to claim 41 configured to compress at least a portion of said HDR video frame according to multiple compression modes to obtain multiple compressed versions of said at least a portion of said HDR video frame and determine, for each compression mode of said multiple compression modes, a respective evaluation measure for said HDR video frame; and
a selector configured to select a compressed version of said at least a portion of said HDR video frame as an encoded representation of said at least a portion of said HDR video frame based on said multiple evaluation measures.

55. The HDR video frame encoding device according to claim 54, wherein said selector is configured to select, as said encoded representation of said at least a portion of said HDR video frame, a compressed version of said HDR video frame having a highest evaluation measure among said multiple compressed versions of said at least a portion said HDR video frame.

56. A non-transitory computer-readable medium storing a computer program comprising instructions that, when executed by a processor, cause said processor to determine an evaluation measure for a high dynamic range, HDR, video frame, said instructions comprising instructions configuring the processor to:
calculate, for each pixel in said HDR video frame, an initial exposure value of said pixel in said HDR video frame using a smallest exposure parameter value;
calculate, for each pixel in said HDR video frame, an initial exposure value of a corresponding pixel in a version of said HDR video frame obtained following compression of said HDR video frame;
calculate, for each pixel in said HDR video frame and for each exposure parameter value starting from said smallest exposure parameter value up to a largest exposure parameter value, an exposure value of said pixel in said HDR video frame from a previously calculated exposure value of said pixel in said HDR video frame multiplied by a constant;
calculate, for each pixel in said HDR video frame and for each exposure parameter value starting from said smallest exposure parameter value up to said largest exposure parameter value, an exposure value of said corresponding pixel in said version of said HDR video frame obtained following compression of said HDR video frame from a previously calculated exposure value of said corresponding pixel in said version of said HDR video frame obtained following compression of said HDR video frame multiplied by said constant;
convert, for each pixel in said HDR video frame and for each exposure parameter value starting from said smallest exposure parameter value up to said largest exposure parameter value, said exposure value of said pixel in said HDR video frame into a low dynamic range, LDR, value for said pixel in said HDR video frame;
convert, for each pixel in said HDR video frame and for each exposure parameter value starting from said smallest exposure parameter value up to said largest exposure parameter value, said exposure value of said corresponding pixel in said version of said HDR video frame obtained following compression of said HDR video frame into a LDR value for said corresponding pixel in said version of said HDR video frame obtained following compression of said HDR video frame;
calculate, for each pixel in said HDR video frame and for each exposure parameter value starting from said smallest exposure parameter value up to said largest exposure parameter value, an error representing a difference between said LDR value for said pixel in said HDR video frame and said LDR value for said corresponding pixel in said version of said HDR video frame obtained following compression of said HDR video frame; and
calculate said evaluation measure based on said errors for all pixels in said HDR video frame and for all exposure parameter values.
